(19) United States
(12) Patent Application Publication
(10) Pub. No.: US 2024/0159094 A1
(43) Pub. Date: May 16, 2024

(54) DIAGNOSTIC APPARATUS, DIAGNOSTIC SYSTEM, AND DIAGNOSTIC METHOD

(71) Applicant: FUJI ELECTRIC CO., LTD., Kanagawa (JP)

(72) Inventor: Shinji YUKAWA, Mie (JP)

(21) Appl. No.: 18/492,914

(22) Filed: Oct. 24, 2023

(30) Foreign Application Priority Data
Nov. 11, 2022 (JP) 2022-181377

(51) Int. Cl. E05F 15/40; E05B 81/58

(52) U.S. Cl. CPC E05F 15/40; E05B 81/58; E05Y 2400/508; E05Y 2900/51; E05Y 2900/531

(57) ABSTRACT

A diagnostic apparatus acquires time series data during a time period in which a door closes, upon occurrence of a condition in which a door-side pin in a train carriage is maintained in a state where a locking device does not restrict the pin from moving downward, the time series data including first time series data of a position of the door, and second time series data of an output of a detector configured to detect whether the pin has dropped. The diagnostic apparatus diagnoses, based on the acquired time series data, an abnormality in a positional relationship between the pin and a car-side recess in an opening and closing direction of the door that is in a locked state.

### CROSS-REFERENCE TO RELATED APPLICATION

This application claims priority to Japanese Patent Application No. 2022-181377, filed on Nov. 11, 2022, the entire contents of which are incorporated herein by reference.

### BACKGROUND

### 1. Field of the Invention

The present disclosure relates to a diagnostic apparatus and the like.

### 2. Description of the Related Art

There are known techniques that diagnose anomalies in a door of a train carriage (see Patent Document 1).

### Related-Art Document

### Patent Document

[Patent Document 1] Japanese Unexamined Patent Application Publication No. 2020-82993

### SUMMARY

In a first aspect of the present disclosure, a diagnostic apparatus is provided. The diagnostic apparatus includes circuitry configured to acquire time series data during a time period in which a door closes, upon occurrence of a condition in which a car-side pin in a train carriage is maintained in a state where a locking device does not restrict the pin from moving downward, the pin being configured to drop into a door-side recess in the train carriage by weight of the pin to allow for a locked state of the door, and the time series data including first time series data of a position of the door and second time series data of an output of a detector configured to detect whether the pin has dropped. The circuitry is configured to diagnose, based on the acquired time series data, an abnormality in a positional relationship between the pin and the recess in an opening and closing direction of the door that is in the locked state.

In a second aspect of the present disclosure, a diagnostic system is provided. The diagnostic system includes circuitry configured to close a door in a train carriage, upon occurrence of a condition in which a car-side pin in the train carriage is maintained in a state where a locking device does not restrict the pin from moving downward, the pin being configured to drop into a door-side recess in the train carriage by weight of the pin to allow for a locked state of the door. The circuitry is configured to acquire time series data during a time period in which a door closes, the time series data including first time series data of a position of the door and second time series data of an output of a detector configured to detect whether the pin has dropped. The circuitry is configured to diagnose, based on the acquired time series data, an abnormality in a positional relationship between the pin and the recess in an opening and closing direction of the door that is in the locked state.

In a third aspect of the present disclosure, a diagnostic method executed by an information processing apparatus is provided. The diagnostic method includes acquiring time series data during a time period in which a door closes, upon occurrence of a condition in which a car-side pin in a train carriage is maintained in a state where a locking device does not restrict the pin from moving downward, the pin being configured to drop into a door-side recess in the train carriage by weight of the pin to allow for a locked state of the door, and the time series data including first time series data of a position of the door and second time series data of an output of a detector configured to detect whether the pin has dropped. The diagnostic method includes diagnosing, based on the acquired time series data, an abnormality in a positional relationship between the pin and the recess in an opening and closing direction of the door that is in the locked state.

In a fourth aspect of the present disclosure, a non-non-transitory computer readable medium storing a program for causing a computer to execute the diagnostic method of the third aspect is provided.

### BRIEF DESCRIPTION OF THE DRAWINGS

FIG. 1 is a block diagram illustrating a configuration example associated with an opening-and-closing operation of a door of a train carriage.

FIG. 2 is a schematic diagram illustrating an example of an arrangement structure of the door and the door drive mechanism of the train carriage.

FIG. 3 is a schematic diagram illustrating an example of the arrangement structure of the door and the door drive mechanism of the train carriage.

FIG. 4 is a schematic diagram illustrating an example of the arrangement structure of the door and the door drive mechanism of the train carriage.

FIG. 5 is a schematic diagram illustrating an example of the arrangement structure of the door and the door drive mechanism of the train carriage.

FIG. 6 is a schematic diagram illustrating an example of the arrangement structure of the door and the door drive mechanism of the train carriage.

FIGS. 7 to 10 are diagrams for describing an example of closing of the door in a diagnostic mode.

FIG. 11 is a diagram illustrating a first example of temporal changes in a motor current and a DLS signal in the diagnostic mode in which the door closes.

FIG. 12 is a diagram illustrating a second example of temporal changes in the motor current and the DLS signal in the diagnostic mode in which the door closes.

FIG. 13 is a sequence diagram illustrating a first example of an abnormality diagnosis process for the door.

FIG. 14 is a sequence diagram illustrating a second example of the abnormality diagnosis process for the door.

FIG. 15 is a diagram illustrating another example of a diagnostic system.

FIG. 16 is a sequence diagram illustrating a third example of the abnormality diagnosis process for the door.

FIG. 17 is a diagram illustrating still another example of the diagnostic system.

FIG. 18 is a sequence diagram illustrating a fourth example of the abnormality diagnosis process for the door.

### DETAILED DESCRIPTION

Related art information relevant to the present disclosure recognized by the inventor of this application is provided below. The door of the train carriage is provided with a locking mechanism for locking the door at a fully closed position and a locking device for driving the locking mechanism.

For example, the locking mechanism includes a door-side recess and a car-side pin. When the pin moves downward by the weight of the pin to be inserted in the recess, the door is held in a locked state. The locking device switches between a first state where the pin is restricted from moving downward toward the recess and a second state where the pin is not restricted from moving downward toward the recess. With this arrangement, when the locking device releases the first state, the pin is inserted in the recess, and thus the door can be locked. Alternatively, when the locking device returns the pin to the first state, the door can be unlocked.

In the locked state of the door, when a positional relationship between the pin and the recess in an opening and closing direction of the door is improper, contact or the like between the pin and the recess occurs, and thus friction is caused in the pin and the recess. As a result, the life of a component (a drive mechanism or the like) for opening and closing the door might be relatively shortened. In addition, there might be cases where the door cannot be locked due to the contact between the pin and the recess. As a result, there might lie a challenge to address the problem that the train carriage cannot operate on time. Therefore, it is desirable to diagnose an abnormality in the positional relationship between the pin and the recess in the opening and closing direction of the door that is held in the locked state.

Patent Document 1 set forth above does not diagnose the abnormality in the positional relationship between the pin and the recess in the opening and closing direction of the door that is held in the locked state. Thus, even if the technique in Patent Document 1 is applied or used, such an abnormality in the positional relationship between the pin and the recess in the opening and closing direction might not be able to be diagnosed.

In view of the above issue recognized by the inventor, an object of the present disclosure is to provide a technique capable of diagnosing an abnormality in the positional relationship between a door-side object and a car-side object (a door-side pin and a car-side recess) in a locking mechanism, when viewed in an opening and closing direction of a door.

Hereinafter, one or more embodiments will be described with reference to the drawings.

### Configuration Associated with Opening and Closing of Door

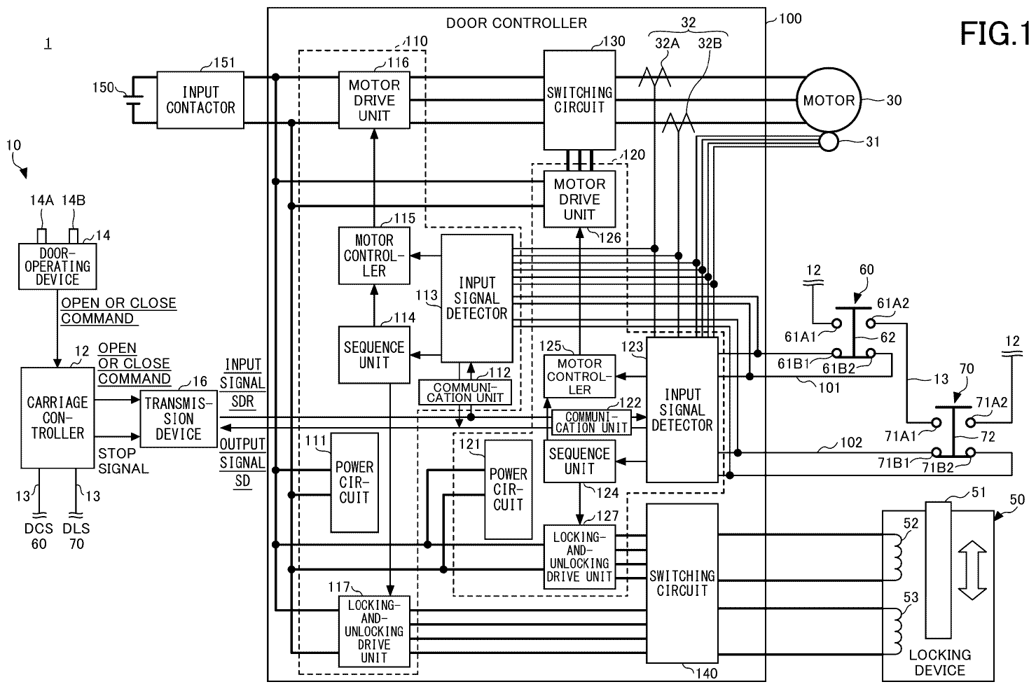

An example of the configuration associated with opening and closing of a door 80 in a train carriage 1 will be described below with reference to FIGS. 1 to 6.

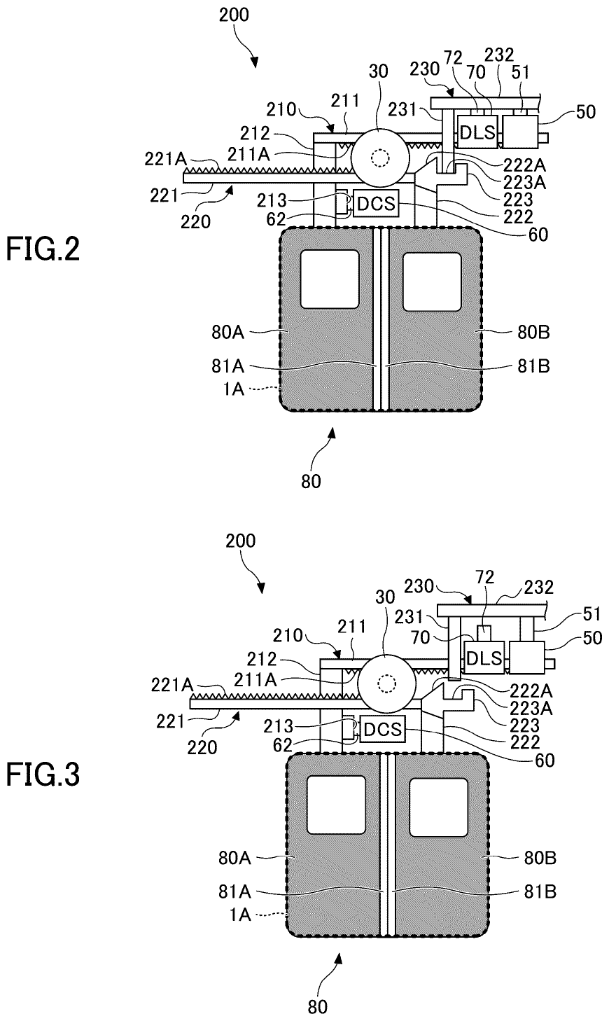

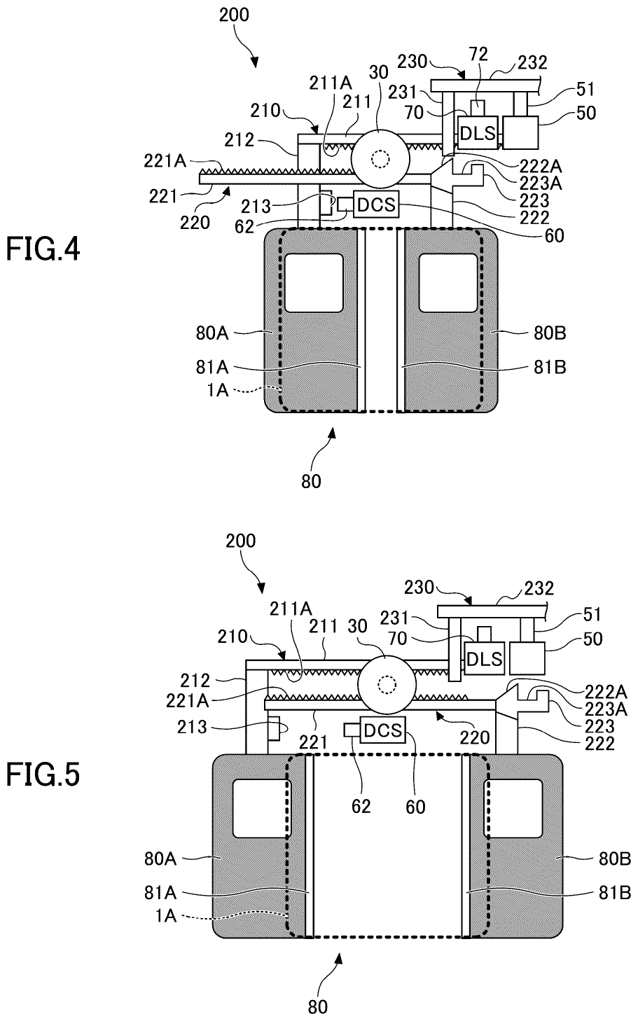

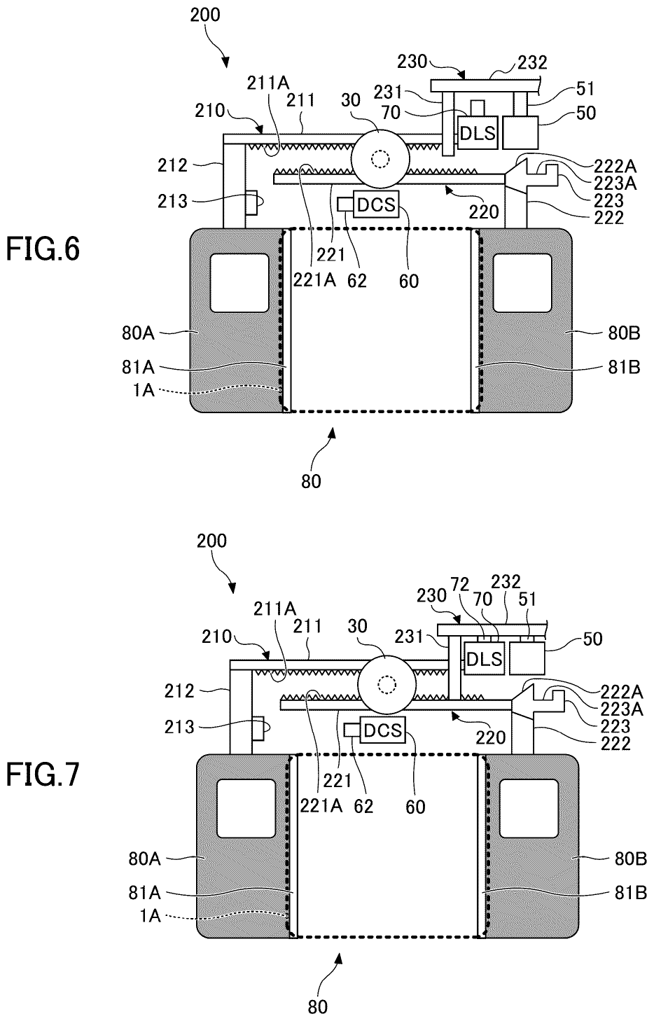

FIG. 1 is a block diagram illustrating a configuration example associated with the opening and closing of the door 80 in the train carriage 1. FIGS. 2 to 6 are diagrams schematically illustrating an example of an arrangement structure of the door 80 and a door drive mechanism 200 in the train carriage 1. Specifically, FIG. 2 is a diagram schematically illustrating the door 80 and the door drive mechanism 200 in a fully closed and locked state of the door 80. FIG. 3 is a diagram schematically illustrating the door 80 and the door drive mechanism 200 in a fully closed and unlocked state. FIG. 4 is a diagram schematically illustrating the door 80 and the door drive mechanism 200, during opening (immediately after the door 80 starts opening) or closing (just before the door 80 finishes closing). FIG. 5 is a diagram schematically illustrating the door 80 and the door drive mechanism 200, during opening (just before the door 80 finishes opening) or closing (immediately after the door 80 starts closing). FIG. 6 is a diagram schematically illustrating the door 80 in the fully opened state of the door drive mechanism 200.

The train carriage 1 may be a single-car carriage that is composed of one car, or may be a plural-car carriage that is composed of a plurality of cars that are linked together.

As illustrated in FIGS. 1 to 6, the train carriage 1 includes a host device 10, a motor 30, an encoder 31, current sensors 32, a locking device 50, a door close switch (DCS) 60, a door lock switch (DLS) 70, and the door 80. The train carriage 1 also includes a door controller 100, a power source 150, an input contactor 151, and the door drive mechanism 200.

The host device 10 includes one or more carriage controllers 12, one or more door-operating devices 14, and a transmission device 16.

The carriage controller 12 performs a control for the operation of the train carriage 1. For example, when train carriages 1 have a plurality of cars, one carriage controller 12 is provided in each of a driver's room in a first car and a conductor's room in a last car. Also, for example, when the train carriage has one car, carriage controllers 12 are respectively provided in a front-side driver's room and a rear-side conductor's room of the train carriage 1 (carriage).

A function of the carriage controller 12 is implemented by any hardware, any combination of hardware and software, or the like. The carriage controller 12 is mainly implemented, for example, by a computer that includes a central processing unit (CPU), a memory device, an auxiliary storage device, and an input-and-output interface device for interfacing with an external device. The memory device is, for example, a static random access memory (SRAM). The auxiliary storage device includes, for example, an electrically erasable programmable read only memory (EEPROM) or a flash memory. The interface device includes, for example, a communication interface for coupling to a communication line that is inside the train carriage 1, or a communication line outside the train carriage 1. The interface device may also include an external interface for coupling an external recording medium. With this arrangement, for example, in a manufacturing process, a worker can install a program or various data, from the external recording medium to the auxiliary storage device or the like of the carriage controller 12, where the program or the various data is to be used to perform a process associated with the operational control of the train carriage 1. The program and various data used to perform the process associated with the operational control of the train carriage 1 may be downloaded from the outside of the train carriage 1, via the communication interface. Further, the interface device may include different types of interface devices, in light of the types of communication lines to be coupled.

When the train carriage 1 is stopped at a station or the like, the carriage controller 12 outputs a stop signal indicating that the train carriage 1 is stopped, to the door controller 100. The carriage controller 12 outputs, to the door controller 100, an open command to open the door 80, or a close command to close the door 80, where the open command or the close command from the door-operating device 14 is input to the door controller 100.

Lines 13 via which an interlock signal is transmitted are coupled to the carriage controller 12. The lines 13 are coupled, at respective ends, to the carriage controller 12, and the DCS 60 and the DLS 70 are provided on the respective lines 13. If at least one of the DCS 60 or the DLS 70 is in an off state, the lines 13 are in a non-conductive state. In this case, the interlock signal that is input to the carriage controller 12 becomes at a L (Low) level. In contrast, if both the DCS 60 and the DLS 70 are in an on state, the lines 13 are in a conductive state. In this case, the interlock signal that is input to the carriage controller 12 becomes at a H (High) level. When the interlock signal is at the H level, the carriage controller 12 determines that the train carriage 1 is in a movable state. With this arrangement, when the interlock signal changes from the L level to the H level, the train carriage 1 can travel.

The door-operating device 14 is used for a crew (for example, a conductor) of the train carriage 1 to open or close the door 80. The door-operating device 14 includes an opening switch 14A and a closing switch 14B. For example, when the opening switch 14A is operated during shutdown of the train carriage 1, the door-operating device 14 outputs the open command to change the interlock signal from the L level to the H level, to the carriage controller 12. Further, for example, when the closing switch 14B is operated during shutdown of the train carriage 1, the door-operating device 14 outputs the close command to change the interlock signal from the H level to the L level, to the carriage controller 12.

The transmission device 16 relays a signal between the door controller 100, which is provided for doors 80 of the train carriage 1, and the carriage controller 12.

Specifically, the transmission device 16 may receive various signals (input signals SDR) that are transmitted from the carriage controller 12 to one or more door controllers 100, and may then transmit the signals to a portion or all of the target door controllers 100. The transmission device 16 may also receive various signals (output signals SD) to be transmitted from respective door controllers 100 to the carriage controller 12, to transmit the signals to the carriage controller 12.

The motor 30 drives the door 80 to open and close. The motor 30 is, for example, a rotary machine that is driven by three-phase alternating current (AC) drive power. The motor 30 may be a linear motor that is driven by three-phase AC drive power. The motor 30 may be a direct current (DC) motor that is driven by direct current.

The encoder 31 detects a rotational position or a displacement position of the motor 30. For example, when the motor 30 is a rotary machine, the encoder 31 detects the rotational position (rotation angle) of a rotary shaft of the motor 30. The encoder 31 detects, for example, the rotational position (rotation angle) of the rotary shaft of the motor 30 that is rotating one time, and detects revolutions per minute (rpm) for the motor 30. The encoder 31 outputs a detection signal including information relating to the rotational position of the rotary shaft of the motor 30, and the detection signal is input to the door controller 100. With this arrangement, the door controller 100 can acquire position information of the door 80 with respect to an open-and-closed direction, based on the signal from the encoder 31. That is, information included in the signal from the encoder 31 corresponds to the position information of the door 80.

Current sensors 32 detect currents of the three-phase AC drive power that is supplied to the motor 30 by the door controller 100. The current sensors 32 include current sensors 32A and 32B that detect currents each of which flows via any two power lines among three power lines of a U-phase, a V-phase, and a W-phase, where the three power lines couple the door controller 100 to the motor 30. For example, the current sensor 32A detects a current for the U-phase power line, and the current sensor 32B detects a current for the W-phase power line. The current sensors 32 may include a current sensor that detects a current for the remaining one power line. For example, as illustrated in FIG. 1, the current sensors 32 may be incorporated in the door controller 100, or may be provided outside the door controller 100. Detection signals from the current sensors 32 (current sensors 32A and 32B) are each input to a normal controller 110 and a backup controller 120 as described below.

The locking device 50 locks and unlocks the door 80. The locking device 50 includes, for example, a pin 51 and coils 52 and 53, and is implemented by bidirectional self-holding solenoids. Each of the coils 52 and 53 is coupled to the door controller 100.

In the locking device 50, when the coil 52 is energized by the door controller 100, the pin 51 is protruded from a housing of the locking device 50. As a result, a lock pin 230 described below moves in an unlock direction, and thus the door 80 is unlocked. In addition, because the locking device 50 is a self-holding type, the locking device 50 maintains a state where the pin 51 protrudes from a housing of the locking device 50 even after the energization of the coil 52 is released. With this arrangement, the door 80 can be maintained in an unlocked state.

In the locking device 50, when the coil 53 is energized by the door controller 100, the pin 51 is drawn into the housing of the locking device 50. As a result, a lock pin 230 described below moves in a lock direction, and thus the door 80 is locked. In addition, because the locking device 50 is the self-holding type, the locking device 50 maintains a state where the pin 51 is drawn into the housing of the locking device 50 even after the energization of the coil 53 is released. With this arrangement, the door 80 can be maintained in a locked state.

The DCS 60 detects whether the door 80 of the train carriage 1 is open or closed. Specifically, the DCS 60 detects a fully closed state in which the door 80 of the train carriage 1 is fully closed. The DCS 60 is implemented, for example, by a limit switch that is pressed by the door 80 that operates when the door 80 moves to a fully closed position.

The DCS 60 includes fixed contacts 61A1 and 61A2, fixed contacts 61B1 and 61B2, and a movable contact 62.

The fixed contacts 61A1 and 61A2 are respectively arranged at ends of two lines into which the line 13 is divided. In the following description, the fixed contacts 61A1 and 61A2 may be referred to as an “A-contact pair” for the DCS 60, for convenience.

The fixed contacts 61B1 and 61B2 are arranged at ends of two lines into which a line 101 is divided, where the two lines are coupled to the door controller 100. With this arrangement, the door controller 100 can identify an on-off state of the DCS 60, in accordance with a H-level signal and a L-level signal, where the H-level signal indicates a conductive state of the fixed contacts 61B1 and 61B2, and the H-level signal indicates a non-conductive state of the fixed contacts 61B1 and 61B2. In the following description, the fixed contacts 61B1 and 61B2 may be referred to as a “B-contact pair” for the DCS 60, for convenience.

When the movable contact 62 moves along an axial direction (vertical direction in FIG. 1), one pair among the A-contact pair (fixed contacts 61A1 and 61A2) and the B-contact pair (fixed contacts 61B1 and 61B2) of the DCS 60 becomes conductive. In the DCS 60, in a state where no external force acts, the movable contact 62 makes the B-contact pair conductive. That is, the DCS 60 is held in a state where the B-contact pair is on and the A-contact pair is off. In contrast, in the DCS 60, as described below, when the movable contact 62 is pressed by the operation of the door 80, the A-contact pair is turned on in a state where the A-contact pair is conducted by the movable contact 62 while the B-contact pair is turned off. Then, in accordance with the operation of the door 80, the movable contact 62 returns to a state of not being pressed. In this case, the DCS 60 returns to a state where the B-contact pair, which is conducted by the movable contact 62, is turned on and the A-contact pair is turned off.

For example, the door controller 100 can identify an on-off state of the B-contact pair for the DCS 60, based on a signal that is input to the door controller 100 via the line 101. Further, for example, the door controller 100 can identify an on-off state of the A-contact pair for the DCS 60, by inverting the signal that is input to the door controller 100 via the line 101.

The DLS 70 detects whether the door 80 is locked. Specifically, the DLS 70 detects the locked state of the door 80. For example, when the lock pin 230 for the door 80 moves to a locking position, the DLS 70 is implemented by a limit switch that is pressed by the operation of the lock pin 230.

The DLS 70 includes fixed contacts 71A1 and 71A2, fixed contacts 71B1 and 71B2, and a movable contact 72.

The fixed contacts 71A1 and 71A2 are respectively arranged at ends of two lines into which the line 13 is divided. In the following description, the fixed contacts 71A1 and 71A2 may be referred to as an “A-contact pair” for the DLS 70, for convenience.

The fixed contacts 71B1 and 71B2 are arranged at ends of two lines into which a line 102 is divided, where the two lines are coupled to the door controller 100. With this arrangement, the door controller 100 can identify an on-off-state of the DLS 70, in accordance with a H-level signal and a L-level signal, where the H-level signal indicates a conductive state of the fixed contacts 71B1 and 71B2, and the H-level signal indicates a non-conductive state of the fixed contacts 71B1 and 71B2. In the following description, the fixed contacts 71B1 and 71B2 may be referred to as a “B-contact pair” for the DLS 70, for convenience.

When the movable contact 72 moves along an axial direction (vertical direction in FIG. 1), one pair among the A-contact pair (fixed contacts 71A1 and 71A2) and the B-contact pair (fixed contacts 71B1 and 71B2) of the DLS 70 becomes conductive. In the DLS 70, in a state where no external force acts, the movable contact 72 makes the B-contact pair conductive. That is, the DLS 70 is held in a state where the B-contact pair is on and the A-contact pair is off. In contrast, in the DLS 70, when the movable contact 72 is pressed by the operation of the lock pin 230, the A-contact pair is turned on, and the B-contact pair is turned off. Then, in the DLS 70, when the movable contact 72 returns to a state of not being pressed by the operation of the lock pin 230, the B-contact pair is turned on, and the A-contact pair is turned off.

For example, the door controller 100 can identify an on-off state of the B-contact pair for the DLS 70, based on a signal that is input to the controller 100 via the line 102. Further, for example, the door controller 100 can identify an on-off state of the A-contact pair for the DLS 70, by inverting the signal that is input to the door controller 100 via the line 102.

When the door 80 is fully closed and locked, both the A-contact pair for the DCS 60 and the A-contact pair for the DLS 70 are turned on, and thus the line 13 becomes conductive. As a result, the interlock signal becomes at the H level.

The door 80 is a double sliding door that is provided at an opening (hereinafter referred to as a “door opening”) in each of a left side surface and a right side surface of a car body of the train carriage 1. The door 80 includes door panels 80A and 80B.

With use of the door panels 80A and 80B, the door 80 (door opening of the car body) is opened or closed using the door drive mechanism 200, in accordance with power from the motor 30. Specifically, the door panels 80A and 80B can close or open the door opening of the car body, by moving the door panels 80A and 80B in opposite directions, i.e., front and back directions, when viewed from a middle portion of the door opening of the car body in a front-and-back directions.

In the fully closed state of the door 80, door end rubbers 81A and 81B are respectively provided at portions of the door panels 80A and 80B that can be in contact with each other. Each of the door end rubbers 81A and 81B is provided in an area from an upper end, to a lower end, of a contact portion of a corresponding door panel with the other door panel, among the door panels 80A and 80B.

The door controller 100 performs a control relating to the opening and closing of the door 80. The door controller 100 is provided for each unit of multiple doors 80 that are provided in the train carriage 1.

A function of the door controller 100 is implemented by any hardware, any combination of hardware and software, or the like. The door controller 100 is mainly implemented, for example, by a computer that includes a central processing unit (CPU), a memory device, an auxiliary storage device, and an interface device for input and output with one or more external devices. The memory device is, for example, an SRAM. The auxiliary storage device includes, for example, an EEPROM, or a flash memory. The interface device includes, for example, a communication interface for coupling a communication line that is inside the train carriage 1. The interface device may also include an external interface for coupling an external recording medium. With this arrangement, for example, in a manufacturing process, an operator can install a program or various data relating to a control process for the door 80, from an external recording medium to be stored in an auxiliary storage device or the like of the door controller 100. The program or various data relating to the control process for the door 80 may be downloaded from the host device 10 through a communication interface. Further, the interface device may include different types of interface devices, in light of types of communication lines to be coupled.

The door controller 100 includes the normal controller 110, the backup controller 120, a switching circuit 130, and a switching circuit 140.

The normal controller 110 performs a control for opening and closing the door 80. The normal controller 110 includes a power circuit 111, a communication unit 112, an input signal detector 113, a sequence unit 114, a motor controller 115, a motor drive unit 116, and a locking-and-unlocking drive unit 117.

The power circuit 111 functions as a drive power source that is used for various devices of the normal controller 110. With use of power of a relatively high voltage (for example, 100 V) that is supplied to the door controller 100 by the power source 150, the power circuit 111 generates power of a relatively low voltage (for example, 5 V or lower) for driving the devices of the normal controller 110.

The communication unit 112 performs a two-way communication with the transmission device 16 that is outside the door controller 100.

The input signal detector 113 detects various signals that are input from the outside of the door controller 100.

The input signal detector 113 may perform various processes based on one or more detected signals.

For example, upon detecting a predetermined signal among input signals, the input signal detector 113 transmits the predetermined signal to the sequence unit 114 or the motor controller 115. That is, the input signal detector 113 extracts (selects) the signal necessary for the control of the sequence unit 114 or the motor controller 115, from multiple types of input signals, and then transmits the signal to the sequence unit 114 or the motor controller 115. With this arrangement, as described below, the sequence unit 114 and the motor controller 115 can appropriately perform a sequence control and a drive control for the motor 30, respectively, based on one or more signals that are input from the input signal detector 113.

The sequence unit 114 performs the sequence control for opening and closing the door 80, based on the signal that is input from the input signal detector 113. Specifically, the sequence unit 114 performs the sequence control for opening and closing the door 80, in accordance with a stop signal, an open command, a close command, and the like that are from the carriage controller 12. The sequence unit 114 also performs the sequence control for opening and closing the door 80, while identifying an open-and-close state of the door 80, a position of the door 80 in the open-and-closed direction, and the presence or absence of the locking of the door 80, and the like, by using signals from the encoder 31, the DCS 60, and the DLS 70, and the like.

The motor controller 115 performs a drive control of the motor 30 such that the door 80 is opened or closed in accordance with a control command that relates to the opening or closing of the door 80 and is from the sequence unit 114. For example, the motor controller 115 generates a pulse width modulation (PWM) signal for driving the motor 30, based on a speed command and a propulsion command of the motor 30 that are input from the sequence unit 114, and then outputs the PWM signal to the motor drive unit 116. Specifically, the motor controller 115 may generate the PWM signal that matches the speed command and the propulsion command, while identifying the current in the motor 30, the rotational position of the rotary shaft of the motor 30, and the like, by using one or more detection signals at the encoder 31, the current sensors 32, and the like, where the detection signals are input from the input signal detector 113.

The motor drive unit 116 generates and outputs three-phase AC power for driving the motor 30, by using the DC power that is input from the power source 150. The motor drive unit 116 includes, for example, an inverter circuit that converts DC into three-phase AC having a predetermined voltage and a predetermined frequency. In the motor drive unit 116, two input-side DC power lines are coupled to the power source 150 through the input contactor 151, and three output-side power lines are coupled to the motor 30 through the switching circuit 130.

The locking-and-unlocking drive unit 117 energizes the coil 52 or 53 of the locking device 50, in accordance with a lock command or an unlock command that is input from the sequence unit 114, and then drives the locking device 50 (pin 51) in a lock direction or an unlock direction of the door 80. In the locking-and-unlocking drive unit 117, input-side DC power lines consisting of a positive line and a negative line are coupled to the power source 150 through the input contactor 151. Also, in the locking-and-unlocking drive unit 117, one among two sets of output-side DC power lines, which consist of a positive line and a negative line, is coupled to the coil 52 through the switching circuit 140, and the other set is coupled to the coil 53 through the switching circuit 140. For example, the locking-and-unlocking drive unit 117 includes a semiconductor switch capable of switching power lines between conduction and non-conduction, where the power lines include a power line between the input-side DC power lines and one set of the output-side DC power lines, and include a power line between the input-side DC power lines and the other set of the output-side DC power lines. The locking-and-unlocking drive unit 117 switches the semiconductor switch on and off. Specifically, in response to receiving the unlock command from the sequence unit 114, the locking-and-unlocking drive unit 117 may shift a power line state between the input-side DC power lines and any one set of the output-side DC power lines, to the conductive state, to thereby energize the coil 52 of the locking device 50 through the switching circuit 140. In addition, in response to receiving the lock command from the sequence unit 114, the locking-and-unlocking drive unit 117 may shift a power line state between the input-side DC power lines and the other set of output-side DC power lines, to the conductive state, to thereby energize the coil 53 of the locking device 50 through the switching circuit 140.

The backup controller 120 is configured to be able to perform the control for opening and closing the door 80, and functions as a backup of the normal controller 110. With this arrangement, in the door controller 100, the backup controller 120 is provided in addition to the normal controller 110, and redundancy of a control system related to the opening and closing of the door 80 is enabled. Specifically, when an abnormality occurs in the normal controller 110, the backup controller 120 performs the control for opening and closing the door 80, instead of using the normal controller 110.

The backup controller 120 includes the same components as those of the normal controller 110. Specifically, the backup controller 120 includes a power circuit 121, a communication unit 122, an input signal detector 123, a sequence unit 124, a motor controller 125, a motor drive unit 126, and a locking-and-unlocking drive unit 127.

The power circuit 121 has the same hardware configuration and function as described in the power circuit 111 of the normal controller 110. The communication unit 122 has the same hardware configuration and function as described in the communication unit 112 of the normal controller 110. The input signal detector 123 has the same hardware configuration and function as described in the input signal detector 113 of the normal controller 110. Further, the sequence unit 124 has the same hardware configuration and function as described in the sequence unit 114 of the normal controller 110. The motor controller 125 has the same hardware configuration and function as described in the motor controller 115 of the normal controller 110. The motor drive unit 126 has the same hardware configuration and function as described in the motor drive unit 116 of the normal controller 110. The locking-and-unlocking drive unit 127 has the same hardware configuration and function as described in the locking-and-unlocking drive unit 117 of the normal controller 110. In light of the above, detailed description thereof is omitted.

The switching circuit 130 switches between a state in which the motor drive unit 116 and the motor 30 are electrically coupled to each other and a state in which the motor drive unit 126 and the motor 30 are electrically coupled to each other. Specifically, three-phase AC output power lines of each of the motor drive unit 116 and the motor drive unit 126 are coupled to an input side of the switching circuit 130, and three-phase AC input power lines that extend from the motor 30 are coupled to an output side of the switching circuit 130. The switching circuit 130 switches between a state in which the output power lines of the motor drive unit 116 and input power lines of the motor 30 conduct and a state in which the output power lines of the motor drive unit 126 and the input power lines of the motor 30 conduct.

The switching circuit 130 maintains a state in which the motor drive unit 116 and the motor 30 are electrically coupled to each other, when the normal controller 110 performs the control for opening and closing the door 80. Also, when the abnormality occurs in the normal controller 110, and then the backup controller 120 performs the control for opening and closing the door 80, the switching circuit 130 switches to a connection state in which the motor drive unit 126 and the motor 30 are electrically coupled to each other.

The switching circuit 140 switches between a state in which the locking-and-unlocking drive unit 117 and the locking device 50 (coil 52 or 53) are coupled to each other and a state in which the locking-and-unlocking drive unit 127 and the locking device 50 (coil 52 or 53) are coupled to each other. Specifically, two sets of output power lines, for each of the locking-and-unlocking drive unit 117 and the locking-and-unlocking drive unit 127, are coupled to an input side of the switching circuit 140, and two sets of input power lines that extend from the locking device 50 (coil 52 and 53) are coupled to an output side of the switching circuit 150. Further, the switching circuit 140 switches between a state in which the two sets of output power lines for the locking-and-unlocking drive unit 117 are coupled to the two sets of input power lines of the locking device 50, and a state in which the two sets of output power lines of the locking-and-unlocking drive unit 127 are coupled to the two sets of input power lines of the locking device 50.

When the normal controller 110 performs the control for opening and closing the door 80, the switching circuit 140 maintains a state in which the locking-and-unlocking drive unit 117 and the locking device 50 (coil 52 or 53) are electrically coupled to each other. Also, when an abnormality occurs in the normal controller 110, and then the backup controller 120 shifts a control state to a state in which the opening and closing of the door 80 are controlled, the switching circuit 140 switches to a state in which the locking-and-unlocking drive unit 127 and the locking device 50 (coil 52 or 53) are electrically coupled to each other.

The power source 150 supplies DC power of a predetermined voltage (for example, 100 volts) to various devices of the train carriage 1, and the various devices include the motor 30, the locking device 50, and the door controller 100. The power source 150 includes, for example, a battery and an auxiliary power source device. The battery supplies DC power to the various devices of the train carriage 1, in a state where a pantograph of the train carriage 1 is not coupled to an overhead line. The auxiliary power source device generates DC power, based on power that is supplied via the overhead line from the pantograph, in a state where the pantograph of the train carriage 1 is coupled to the overhead line. Then, the auxiliary power source device supplies the DC power to the various devices of the train carriage 1.

The input contactor 151 is provided in a power circuit between the power source 150 and various devices that include the door controller 100. The input contactor 151 switches between supply of power to the various devices of the train carriage 1 and interruption of the supply, by opening and closing the power circuit. The input contactor 151 is closed, for example, in accordance with a predetermined operation, such as power-up that is enabled in a driver's room of the train carriage 1. With this arrangement, power is supplied to various devices of the train carriage 1, including the door controller 100, and thus the train carriage 1 is activated. In addition, the input contactor 151 is opened, for example, in accordance with a predetermined operation such as power-down that is enabled in the driver's room of the train carriage 1. With this arrangement, supply of power to various devices of the train carriage 1 including the door controller 100 is stopped (interrupted), and thus the train carriage 1 is stopped.

The door drive mechanism 200 transmits the power of the motor 30 to the door 80 to open or close the door 80. The door drive mechanism 200 implements the locked state or the unlocked state of the door 80, in accordance with the movement of the locking device 50 (pin 51).

The door drive mechanism 200 includes racks 210 and 220 and the lock pin 230.

The rack 210 is attached to an upper end portion of the door panel 80A. The rack 210 includes a rack portion 211 and a connection portion 212.

The rack portion 211 is a member that extends in the front-and-back direction of the train carriage 1. A rack gear 211A is provided on a lower surface of the rack portion 211. The rack portion 211 is disposed above the door opening of the train carriage 1 (car body) to be slightly above the rotary shaft of the motor 30 whose rotary shaft is disposed along a width direction (left-right direction) of the train carriage 1. With this arrangement, a pinion gear, which is disposed coaxially with the rotary shaft of the motor 30, can be engaged with the rack gear 211A on the lower surface of the rack portion 211. Thus, the rack portion 211 can be moved in the front-and-back direction of the train carriage 1, in accordance with the rotation of the motor 30.

The connection portion 212 couples the door panel 80A and the rack portion 211. The connection portion 212 is provided so as to extend upward from an upper end portion of the door panel 80A, and the rack portion 211 is coupled to an upper end portion of the connection portion 212. With this arrangement, the door panel 80A moves in the front-and-back direction of the train carriage 1, in conjunction with the movement of the rack portion 211 that corresponds to the rotation of the motor 30, and the opening-and-closing operation of the door 80 can be realized. In this case, the movement of the door panel 80A in the front-and-back direction is guided by a slide rail (hereinafter referred to as a “door rail”).

A DCS contact 213 is provided with the connection portion 212.

As illustrated in FIGS. 2 and 3, when the door panels 80A and 80B transition to the fully closed state, the DCS contact 213 comes into contact with the movable contact 62 of the DCS 60, and thus the movable contact 62 is pressed. With this arrangement, the movable contact is pushed to turn the DCS 60 on. In contrast, as illustrated in FIGS. 4 to 6, when the door panels 80A and 80B transition to a state other than the fully closed state of the door panel 80A, the DCS contact 213 transitions to a state in which the DCS contact 213 does not contact the movable contact 62 of the DCS 60, and thus the DCS 60 is turned off.

The rack 220 is attached to an upper end portion of the door panel 80B. The rack 220 includes a rack portion 221, the connection portion 212, and the lock-pin contact portion 223.

The rack portion 221 is a member that extends in the front-back direction of the train carriage 1. A rack gear 221A is provided on an upper surface of the rack portion 221. The rack portion 221 is disposed above the door opening of the train carriage 1 to be slightly below the rotary shaft of the motor 30. With this arrangement, the pinion gear disposed coaxially with the rotary shaft of the motor 30 can be engaged with the rack gear 211A on the upper surface of the rack portion 221. Thus, the rack portion 221 can be moved in the front-and-back direction of the train carriage 1, in accordance with the rotation of the motor 30.

The connection portion 222 couples the door panel 80B and the rack portion 221. The connection portion 222 is provided so as to extend upward from the upper end portion of the door panel 80B, and the rack portion 221 is coupled to the upper end portion of the connection portion 222. With this arrangement, the door panel 80B moves in the front-and-back direction of the train carriage 1, in conjunction with the movement of the rack portion 221 that corresponds to the rotation of the motor 30, and the opening-and-closing operation of the door 80 can be realized. In this case, the movement of the door panel 80B in the front-and-back direction is guided by a slide rail (door rail).

In this description, the rack gear 211A is engaged with the pinion gear that is disposed coaxially with the motor 30, when viewed from above. The rack gear 221A is engaged with the pinion gear, when viewed from below. Thus, the racks 210 and 220 can be moved in an opposite direction, in accordance with the rotation of the motor 30. Therefore, the opening and the closing of the two door panels 80A and 80B can be realized using one motor 30.

An inclined portion 222A that slopes down toward a middle side of the door opening, with respect to the front-and-back direction of the train carriage 1, is provided at the upper end portion of the connection portion 222.

In the locked state of the door 80, the lock-pin 230 is in contact with the lock-pin contact portion 223. The lock-pin contact portion 223 is provided so as to protrude from an end side of the connection portion 222, where the end side is opposite a direction in which the rack portion 221 extends. A lock hole 223A is provided in the lock-pin contact portion 223.

The lock hole 223A is a recess that is provided at the upper surface of the lock-pin contact portion 223. When the door 80 is locked, a lower end of the lock pin 230 (a pin 231 described below) is inserted in the lock hole 223A.

The lock pin 230 is provided above the lock-pin contact portion 223 of the rack 220. The lock pin 230 includes the pin 231 and a locking-device contact portion 232.

The pin 231 is provided to extend in the vertical direction.

The locking-device contact portion 232 is attached to an upper end portion of the pin 231, and is provided so as to extend from a connection with the pin 231 in a horizontal direction. Specifically, the locking-device contact portion 232 is provided to extend in a direction opposite the direction in which the door opening extends in the front-and-back direction of the train carriage 1. The locking device 50 is fixedly disposed below the locking-device contact portion 232, and the upper end portion of the pin 51 of the locking device 50 contacts the lower surface of the locking-device contact portion 232. With this arrangement, when the pin 51 of the locking device 50 is protruded upward, the locking-device contact portion 232 moves upward, and when the pin 51 of the locking device 50 is drawn in a downward direction, the locking-device contact portion 232 moves downward by the weight of the lock pin 230.

As illustrated in FIGS. 3 to 6, in a state in which the pin 51 of the locking device 50 is protruded, the lower end of the pin 231 that is coupled to the locking-device contact portion 232 is positioned higher than the inclined portion 222A of the rack 220, and thus the pin 231 does not engage with the lock hole 223A. With this arrangement, the rack 220 can move without being influenced by the arrangement of the lock pin 230, and thus the door 80 (the door panels 80A and 80B) becomes in a state of being movable in the open and closed directions.

In contrast, as illustrated in FIG. 2, in a state where the pin 51 of the locking device 50 is drawn, the lower end of the pin 231 is positioned lower than the inclined portion 222A of the rack 220. Further, in the fully closed state of the door 80, the pin 231 is positioned closer to the lock-pin contact portion 223 than the inclined portion 222A in the front-and-back direction of the train carriage 1. With this arrangement, when the pin 51 of the locking device 50 is drawn in the fully closed state of the door 80, the locking-device contact portion 232 moves downward, and thus the pin 231 engages with the lock hole 223A (protruding portion) of the rack 220. As a result, the movement of the rack 220 is restricted, and the rotation of the pinion gear that engages with the rack gear of the rack 220 is restricted. Thus, the movement of the rack 210 having the rack gear 211A that engages with the pinion gear is restricted. Therefore, the movement of the door panels 80A and 80B that are respectively coupled to the racks 210 and 220 is restricted, and the locked state of the door panels 80A and 80B is held.

### Abnormality Diagnosis for Door

Hereinafter, the abnormality diagnosis for the door 80 will be described with reference to FIGS. 7 to 10. In this description, a subject that diagnoses the abnormality in the door 80 will be described as a diagnostic system SYS, for convenience.

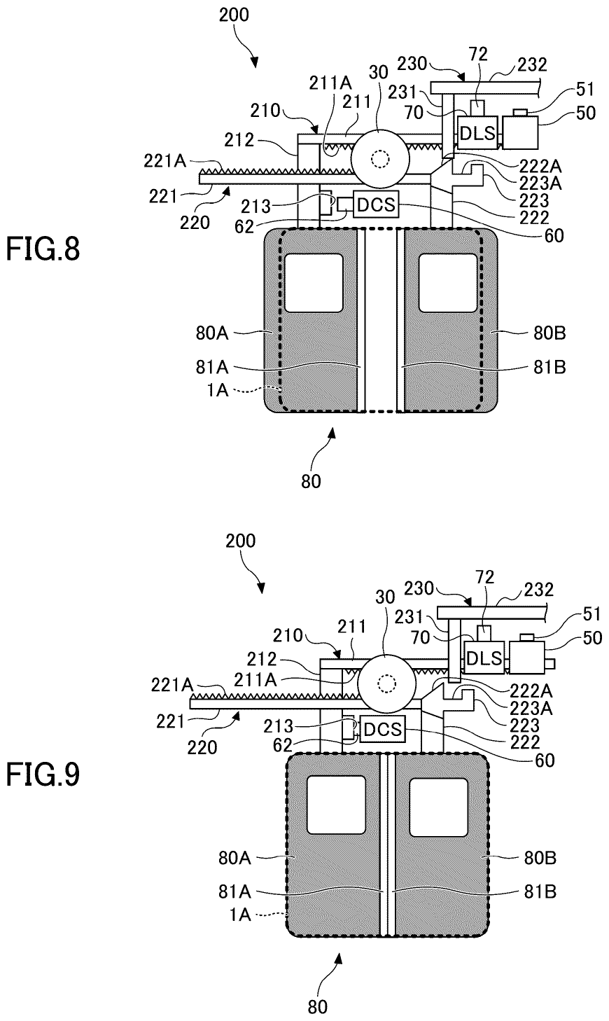

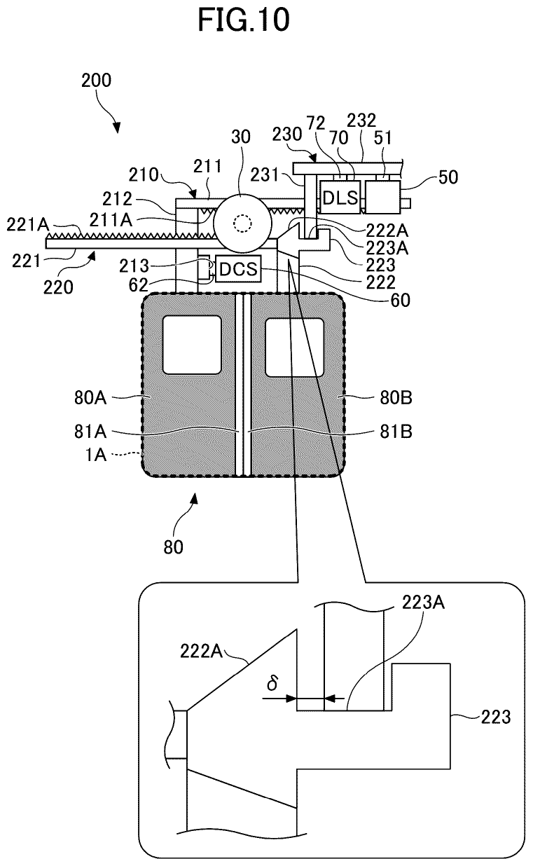

FIGS. 7 to 10 are diagrams for describing an example of the closing of the door 80 in the diagnostic mode. Specifically, FIGS. 7 to 10 are time-series diagrams illustrating the example of the closing of the door 80 in the diagnostic mode. FIG. 7 is a diagram illustrating a starting position of the door 80 that opens in the diagnostic mode. In other words, FIG. 7 illustrates a state of the door 80 that is at the fully opened position. FIG. 8 is a diagram illustrating a state of the door 80 that is between the fully closed position and the fully opened position in the diagnostic mode. FIG. 9 is a diagram illustrating a state of the door 80 that reaches a position in proximity to the fully closed position and is not locked in the diagnostic mode. FIG. 10 is a diagram illustrating a state of the door 80 that reaches the position in proximity to the fully closed position and is locked in the diagnostic mode.

The door controller 100 (each of the motor controller 115 or the motor controller 125) has the normal mode and the diagnostic mode, as control modes that relate to each of opening and closing of the door 80.

The normal mode is a control mode relating to each of the opening and closing of the door 80, and is used when a passenger of the train carriage 1 gets on and off through the door opening. In the normal mode, the door controller 100 operates (travels) the door 80 at a constant speed V1.

The diagnostic mode is a control mode relating to each of the opening and closing of the door 80, and is used to measure (acquire) data for diagnosing an abnormality in the door 80. In an example of the diagnostic mode for the door 80, the door controller 100 operates (travels) the door 80 at a constant speed V2. With this arrangement, accuracy in measuring the position of the door 80 based on the output of the encoder 31 described below can be improved. The speed V2 may be lower than the speed V1 (V2<V1).

The speed V2 may be the same as the speed V1, or may not be a constant speed.

The abnormality diagnosis includes, for example, diagnosing of the presence or absence of an abnormality, diagnosing of a degree of abnormality, and the like. The abnormality diagnosis may include diagnosing of the presence or absence of a sign of the abnormality. The diagnosing of the abnormality in the door 80 includes, for example, diagnosing of an abnormality in the positional relationship between the lock pin 230 (pin 231) and the lock hole 223A in a case where the door 80 is in the fully closed state. The abnormality in the positional relationship between the pin 231 and the lock hole 223A in the case where the door 80 is in the fully closed state means a case where a clearance between the pin 231 and the lock hole 223A in the opening and closing direction of the door 80 is smaller than a reference value representing a normal state in which the door 80 is in the fully closed state. The case where the clearance between the pin 231 and the lock hole 223A in the opening and closing direction of the door 80 is smaller than the reference value includes a case where there is no clearance between the pin 231 and the lock hole 223A. In addition, the case where the clearance between the pin 231 and the lock hole 223A in the opening and closing direction of the door 80 is smaller than the reference value includes a case where, when the door 80 is in the fully closed state, the pin 231 contacts the connection portion 222, and thus the pin 231 cannot drop into the lock hole 223A.

For the abnormality in the positional relationship between the pin 231 and the lock hole 223A in the opening and closing direction of the door 80 that is in the locked state, its various factors are assumed. For example, the abnormality in the positional relationship between the pin 231 and the lock hole 223A in the opening and closing direction of the door 80 that is in the locked state may occur due to (i) changes in a repulsive force that is applied by the door tip rubbers 81A and 81B, (ii) a preset tilt of the door rail, or (iii) distortion or the like in the car body of the train carriage 1.

Hereinafter, the diagnostic mode is described as the control mode for diagnosing the abnormality in the positional relationship between the pin 231 and the lock hole 223A, in a case where the door 80 is in the fully closed state.

As illustrated in FIGS. 7 to 10, in the diagnostic mode, the door controller 100 causes the door 80 to be closed by moving the door 80 from the fully opened position to the fully closed position.

Specifically, the door controller 100 closes the door 80 in a state in which the pin 51 of the locking device 50 is at a locked position (retracted position) in the entire section from the fully opened position to the fully closed position. With this arrangement, the door 80 is closed by moving from the fully opened position to the fully closed position, in a state where the lock pin 230 is not restricted from moving (dropping) downward by the pin 51. Thus, at a starting position at which the door 80 closes, the lock pin 230 (pin 231) is held in a state in which a lower end of the lock pin 230 is lowered to a movable bottom position, where the output (hereinafter a “DLS signal”) of the DLS 70 is at a H level indicating the locked state (see FIG. 7). Then, in accordance with the progress of the closing of the door 80, the lower end of the pin 231 moves up so as to be guided by the inclined portion 222A, and thus the lock pin 230 transitions to a state in which the lock pin 230 does not contact the movable contact 72 of the DLS 70. With this approach, the DLS signal changes from the H level to the L level (see FIG. 8). Then, when the door 80 reaches a position in proximity to the fully closed position, the entire pin 231 is covered by an area of the lock hole 223A in the front-and-back direction (see FIG. 9), and thus the lock pin 230 moves (drops) downward by the weight of the lock pin 230. As a result, the pin 231 is inserted in the lock hole 223A (see FIG. 10). In this case, the DLS signal changes from the L level to the H level.

In the diagnostic mode, the door 80 may not be closed from the fully opened position. Specifically, in the diagnostic mode, it is sufficient when a change from a state in which the lock pin 230 (pin 231) is disposed on the upper end of the connection portion 222, to a state in which the lock pin 230 (pin 231) drops down by the weight of the lock pin 230 is detected. Thus, for example, in the diagnostic mode, the door 80 may be closed from a position at which the door 80 is slightly moved from the fully closed position in the opening direction. With this arrangement, an operating time of the door 80 in the diagnostic mode can be reduced. As a result, a time required to diagnose the abnormality in the positional relationship between the pin 231 and the lock hole 223A, in the case where the door 80 is at the fully closed state, is reduced, thereby increasing operating efficiency.

In the diagnostic mode, the door controller 100 measures (acquires) the position of the door 80 during closing of the door 80, and measures (acquires) time series data of the DLS signal. In the diagnostic mode, the door controller 100 may measure (acquire) time-series data of the speed of the door 80. The position and speed of the door 80 are measured (acquired) based on the output of the encoder 31.

In the fully closed state of the door 80, the diagnostic system SYS diagnoses an abnormality in the positional relationship between the pin 231 and the lock hole 223A, based on the position of the door 80 in the diagnostic mode and measurement data of the DLS signal.

For example, in the fully closed state of the door 80, the diagnostic system SYS estimates (evaluates) the positional relationship (a clearance δ in FIG. 10) between the pin 231 and the lock hole 223A, in accordance with procedures (A-1) to (A-5) described below.

### A-1

The diagnostic system SYS acquires a timing (time t1) at which the DLS signal changes from off (L level) to on (H level), based on the time-series measurement data, indicating the position of the door 80 in the diagnostic mode, and the measurement data of the DLS signal.

### A-2

The diagnostic system SYS estimates a time t0, based on the acquired time t1 and an expected time difference Δt between the timing (time t0), at which the lock pin 230 starts dropping, and the timing (time t1), at which the DLS 70 is turned on by the lock pin 230.

Specifically, the diagnostic system SYS may calculate the time t0 by going back from the acquired time t0 by the time difference Δt. The time difference Δt is preset, for example, through an experiment or a simulation.

The factor of the time difference Δt includes, for example, a physical difference between a height of the locking-device contact portion 232 (lower end) that starts dropping and a height of the DLS 70 that is located when the movable contact 72 is turned on, or includes a time difference or the like between a timing at which the DLS 70 (movable contact 72) becomes on and a timing at which the DLS signal becomes on. The above time difference may occur depending on specifications or the like of a receiving circuit that receives an on or off state of the movable contact 72 and that is incorporated in the DLS 70. When it is determined that there is no problem even if the time difference Δt is ignored, a timing at which the DLS signal changes from off to on may be assumed as the timing (time t0) at which the lock pin 230 starts dropping, without considering the time difference Δt. In this case, the procedure (A-2) is omitted.

### A-3

Based on time-series measurement data of the position of the door 80 and an estimation result at the time t0, the diagnostic system SYS estimates the position P0 of the door 80 that is closed at the time t0 of the lock pin 230.

### A-4

The diagnostic system SYS acquires a fully closed position P2 of the door 80, based on the time-series measurement of the position of the door 80 in the diagnostic mode in which the door 80 closes.

For example, even when the door 80 reaches the fully closed position P2, the door controller 100 continues to drive the door 80 in the closing direction for at least a certain time period. With this arrangement, the door panels 80A and 80B are maintained in a state of being pressed against each other through the motor 30 for at least the certain time period, in a case where the closed door 80 is at the fully closed position. Thus, with use of time series data of the position of the door 80 that is being closed, the diagnostic system SYS can acquire, as the fully closed position P2 of the door 80, a position of the door 80 that has stopped changing.

The order of the procedures (A-1) to (A-4) may be changed as appropriate.

### A-5

Based on the acquired position P0 and the fully closed position P2 of the door 80, the diagnostic system SYS estimates the clearance δ between the pin 231 and the lock hole P0 in the opening and closing direction of the door 80 that is in the fully closed state.

Specifically, the diagnostic system SYS calculates a difference between the acquired position P0 and the fully closed position P2 of the door 80, as the clearance δ (δ=|P0-P2|).

In the fully closed state of the door 80, the diagnostic system SYS may estimate the positional relationship (clearance δ) between the pin 231 and the lock hole 223A, in accordance with procedures (B-2) to (B-5) described below, instead of the above procedures (A-2) to (A-5).

### B-2

The diagnostic system SYS acquires the position P1 of the door 80 at the timing (time t1) at which the DLS signal changes from off to on, based on time-series measurement data, indicating the position of the door 80 in the diagnostic mode, and the time P1 acquired in the procedure (A-1).

### B-3

The diagnostic system SYS acquires the fully closed position P2 of the door 80, based on the time series measurement of the position of the door 80 in the diagnostic mode.

### B-4

Based on the acquired position P1 and the fully closed position P2 of the door 80, the diagnostic system SYS calculates a travel distance TL2 of the door 80 that reaches the fully closed position after the DLS signal changes from off to on.

Specifically, the diagnostic system SYS calculates, as the travel distance TL2 (TL2=|P1-P2|), a difference between the acquired position P1 and the fully closed position P2 of the door 80.

### B-5

The diagnostic system SYS estimates the clearance δ, based on the travel distance TL1 and the acquired travel distance TL2, where the travel distance TL1 is a distance that the door 80 moves during a time period from the dropping of the lock pin 230 to the timing at which the DLS 70 is turned on by the lock pin 230.

Specifically, the diagnostic system SYS calculates the sum of the travel distances TL1 and TL2 of the door 80, as the clearance δ (δ=TL1+TL2).

The travel distance TL1 is predefined, for example, based on the above time difference Δt and a control pattern for the speed V2 in the diagnostic mode. Further, the travel distance TL1 may be estimated (calculated) based on the time difference Δt and a time series of the actual speed of the door 80 in the diagnostic mode.

Instead of the clearance δ, for example, the travel distance TL2 between a position of the door 80, at a timing at which the DLS 70 is turned on, and the fully closed position of the door 80, may be used as a value index of the positional relationship between the pin 231 and the lock hole 223A in the opening and closing direction of the door 80 that is in the fully closed state. In this case, the procedure (B-5) is omitted.

When an estimation result of the clearance δ is relatively smaller that a predetermined criterion (threshold δth), the diagnostic system SYS determines an abnormality exists in the positional relationship between the pin 231 and the lock hole 223A in the opening and closing direction of the door 80 that is in the fully closed state. A case where the clearance δ is relatively small compared to the threshold δth may include a case where the clearance δ is smaller than or equal to the threshold δth, or may include a case where the clearance δ is smaller than the threshold δth.

In addition, based on a history of the result (clearance δ) of the abnormality diagnosis for a target door 80, the diagnostic system SYS may diagnose the presence or absence of the sign of an abnormality in the positional relationship between the pin 231 and the lock hole 223A in the opening and closing direction of the door 80 that is in the fully closed state.

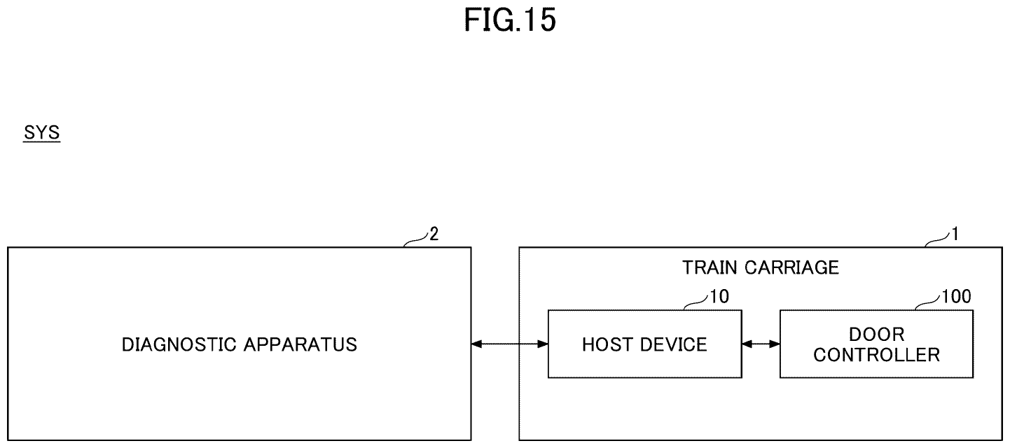

The diagnostic system SYS may use diagnosis results (clearances 5) of a large number of doors 80, where the diagnosis results correspond to big data (see FIGS. 15 to 18). In this case, the diagnostic system SYS may apply machine learning (unsupervised learning) such as clustering, based on information of the diagnostic results of the large number of doors 80, to diagnose the presence or absence of the sign of the abnormality in the positional relationship between the pin 231 and the lock hole 223A in the opening and closing direction of a target door 80 that is in the fully closed state.

As described above, the diagnostic system SYS uses the diagnostic mode to close the door 80 in a state in which the pin 51 of the locking device 50 is at the locked position (retracted position) in the entire section from the fully opened position to the fully closed position. With this arrangement, the diagnostic system SYS can associate the position of the lock pin 230 (pin 231) with the position of the door 80 that is being closed. Thus, the diagnostic system SYS can evaluate the positional relationship between the pin 231 and the lock hole 223A in the opening and closing direction of the door 80 that is in the fully closed state of the door 80, based on time series data of the DLS signal and the position of the door 80 that is being closed in the diagnostic mode. Therefore, the diagnostic system SYS can diagnose an abnormality in the positional relationship.

### Specific Examples of Abnormality Diagnosis for Door

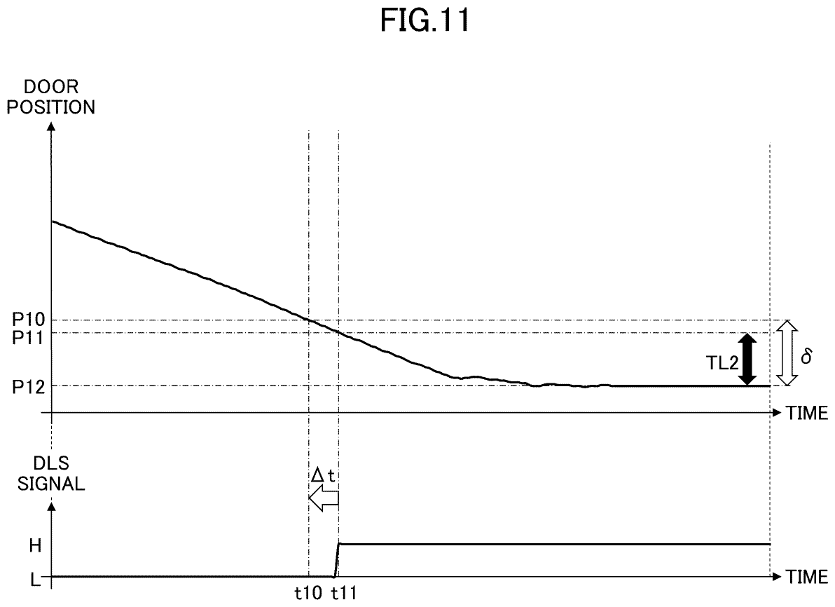

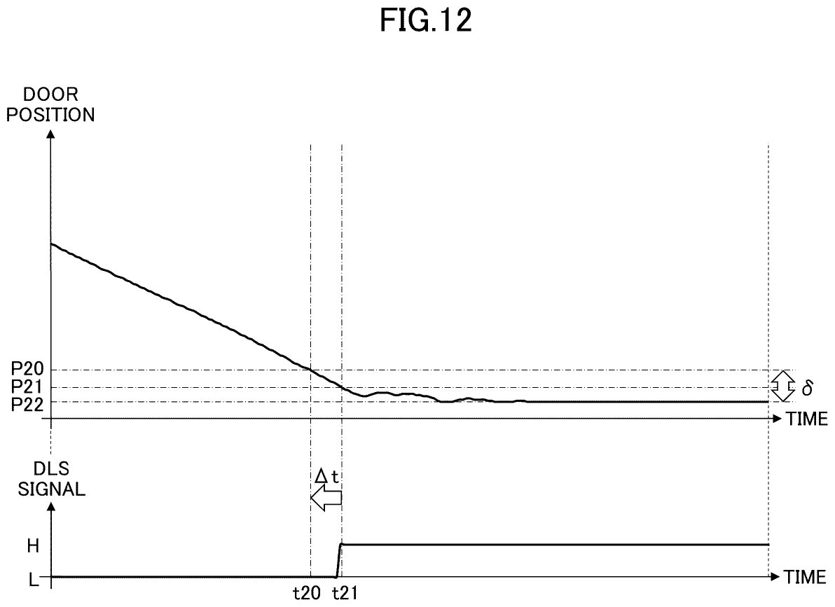

Hereinafter, specific examples of the abnormality diagnosis for the positional relationship between the pin 231 and the lock hole 223A in the opening and closing direction of the door 80 that is in the fully closed state will be described with reference to FIGS. 11 and 12.

FIG. 11 is a diagram illustrating an example of temporal changes in the position of the door 80 and the DLS signal in the diagnostic mode in which the door 80 closes. FIG. 12 is a diagram illustrating another example of temporal changes in the position of the door 80 and the DLS signal in the diagnostic mode in which the door 80 closes.

A time t10 and a time t1l in FIG. 11 respectively correspond to the time t0 and the time t1 described above. A position P10, a position P11, and a position P12 of the door 80 in FIG. 11 respectively correspond to the position PC, the position P1, and the fully closed position P2 of the door 80 described above. Likewise, a time t20 and a time t21 in FIG. 12 respectively correspond to the time t0 and the time t1 described above, and a position P20, a position P21, and a position P22 of the door 80 in FIG. 12 respectively correspond to the position PC, the position P1, and the fully closed position P2 of the door 80 described above.

In the example illustrated in FIG. 11, the difference between the position P10 of the door 80, at which the lock pin 230 starts dropping, and the position P12, corresponding to the fully closed position P2 of the door 80, is relatively great. With this arrangement, in this example, the clearance δ, derived from the difference between the positions P10 and P12, becomes relatively larger than a predetermined criterion (threshold δth). Thus, in this example, the diagnostic system SYS diagnoses that no abnormality exists in the positional relationship between the pin 231 and the lock hole 223A in the opening and closing direction of the door 80 that is in the fully closed state, and thus the positional relationship is normal.

In contrast, in the example illustrated in FIG. 12, the difference between the position P20 of the door 80, at which the lock pin 230 starts dropping, and the position P22, corresponding to the fully closed position P22 of the door 80, is very small. With this arrangement, in this example, the clearance δ, derived from the difference between the positions P20 and P22, becomes relatively smaller than the predetermined criterion (threshold δth). Thus, in this example, the diagnostic system SYS diagnoses that an abnormality exists in the positional relationship between the pin 231 and the lock hole 223A in the opening and closing direction of the door 80 that is in the fully closed state.

### First Example Related to Abnormality Diagnosis Process for Door

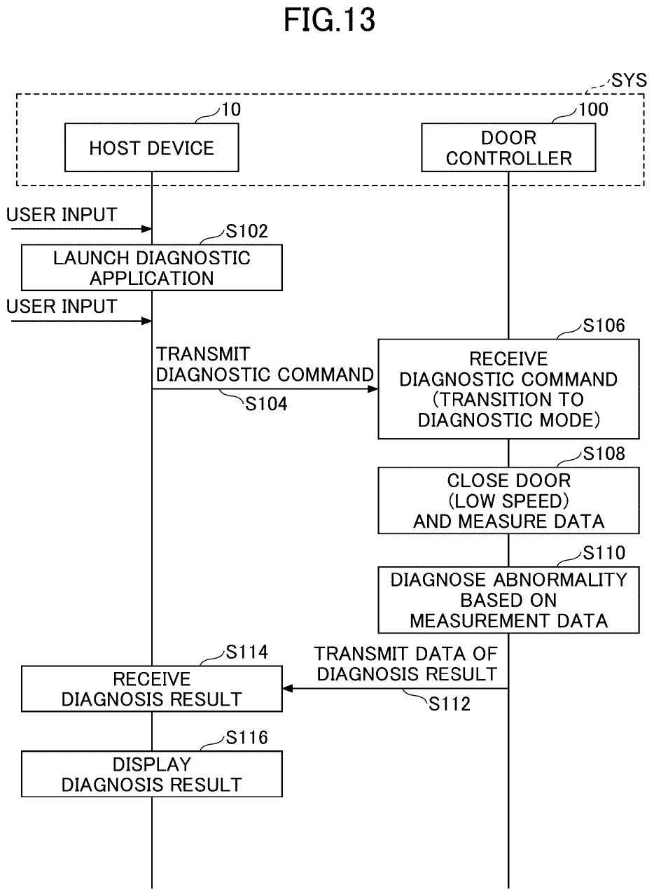

Hereinafter, a first example related to an abnormality diagnosis process for the door 80 will be described with reference to FIG. 13.

FIG. 13 is a sequence diagram illustrating the first example related to the abnormality diagnosis process for the door 80.

In this example, the diagnostic system SYS is provided in the train carriage 1, and includes a host device 10 and a door controller 100.

In this example, a case where in the door controller 100, the normal controller 110, among the normal controller 110 and the backup controller 120, performs the control for the door 80.

As illustrated in FIG. 13, the carriage controller 12 of the host device 10 launches an application program (hereinafter referred to as a “diagnostic application”) related to the abnormality diagnosis for the door 80, in response to receiving a predetermined input from a user, such as a crew in a driver's room or a conductor's room (step S102).

After the process in step S102 is completed, the carriage controller 12 transmits a diagnostic command to the door controller 100 via the transmission device 16, in response to receiving a predetermined input from the user to request to start the abnormality diagnosis for the door 80 (step S104).

The diagnostic command may be used to diagnose an abnormality in all doors 80 of the train carriage 1, or may be used to diagnose the abnormality in only a portion of all the doors 80 of the train carriage 1. In the latter case, the portion of all the doors 80 on which the abnormality diagnosis is to be performed is designated by an input from the user, and the diagnostic command is transmitted to only one or more door controllers 100 that control one or more doors 80 on which the abnormality diagnosis is to be performed.

The input signal detector 113 of the door controller 100 receives the diagnostic command transmitted in the process in step S104, through the communication unit 112, and the motor controller 115 of the door controller 100 shifts a control mode for the door 80 to the diagnostic mode (step S106).

When the process in step S106 is completed, the motor controller 115 and the locking-and-unlocking drive unit 117 of the normal controller 110 close the door 80 in the diagnostic mode, and the input signal detector 113 measures data that is obtained during closing of the door 80 (step S108). The closing of the door 80 in the diagnostic mode means that the door 80 is closed at a constant speed V2 and in a state where the pin 51 of the locking device 50 is maintained at a locked position. As described above, data to be measured includes data indicative of the position of the door 80, data indicative of the DLS signal, and data or the like indicative of the speed of the door 80, where each data is measured during closing of the door 80.

When the process in step S108 is completed, the input signal detector 113 performs abnormality diagnosis for the door 80, based on measurement data obtained in step S108 (step S110).

When the process in step S110 is completed, the input signal detector 113 transmits data indicative of a result of the abnormality diagnosis for the door 80 in step S110, to the host device 10 through the communication unit 112 (step S112).

The carriage controller 12 of the host device 10 receives the data transmitted in the process in step S112, through the transmission device 16, where the data indicates the result of the abnormality diagnosis for the door 80 (step S114).

When the process in step S114 is completed, the carriage controller 12 displays the result of the abnormality diagnosis for the door 80, on a display device in a driver's room or a conductor's room, for example (step S116).

With this arrangement, a user such as a crew in a driver's room or a conductor's room can check the result of the abnormality diagnosis for the door 80.

As described above, in this example of the diagnostic system SYS, in response to receiving a request that is input from the user through the host device 10, the door controller 100 acquires data in the diagnostic mode in which the door 80 closes, and subsequently performs abnormality diagnosis for the door 80. Then, in the diagnostic system SYS, the door controller 100 transmits the data that indicates the result of the abnormality diagnosis for the door 80, to the host device 10, and finally provides the result of the abnormality diagnosis for the door 80 to the user, by using the host device 10.

As a result, in the driver's room or the conductor's room, the user can check the result of abnormality diagnosis for all the doors 80 of the train carriage 1. An amount of data that is communicated between the host device 10 and the door controller 100 is relatively smaller than an amount of measurement data that is obtained during closing of the door 80, such as diagnostic command data, or data indicative of a result of abnormality diagnosis. For this reason, the amount of data that is communicated between the host device 10 and the door controller 100 can be suppressed to be relatively small.

In proximity to a target door 80 of the train carriage 1 on which abnormality diagnosis is performed, a request for abnormality diagnosis is input from the user, and thus a result of the abnormality diagnosis may be provided to the user. For example, in the door controller 100 provided in a car body that is at a space above the door 80, the door controller 100 may include an input device that receives an input of a user's request for abnormality diagnosis, and may include a notification device (for example, an indicator or the like) that notifies the user of the result of abnormality diagnosis. With this arrangement, for example, a user such as an inspection worker enables abnormality diagnosis for each door 80, and then the user can check a result of the abnormality diagnosis for the door 80, at a place where the door 80 is installed. In addition, because there is no need to communicate data relating to abnormality diagnosis for the door 80, between the host device 10 and the door controller 100, an amount of data that is communicated between the host device 10 and the door controller 100 can be further suppressed.

### Second Example of Abnormality Diagnosis Process for Door

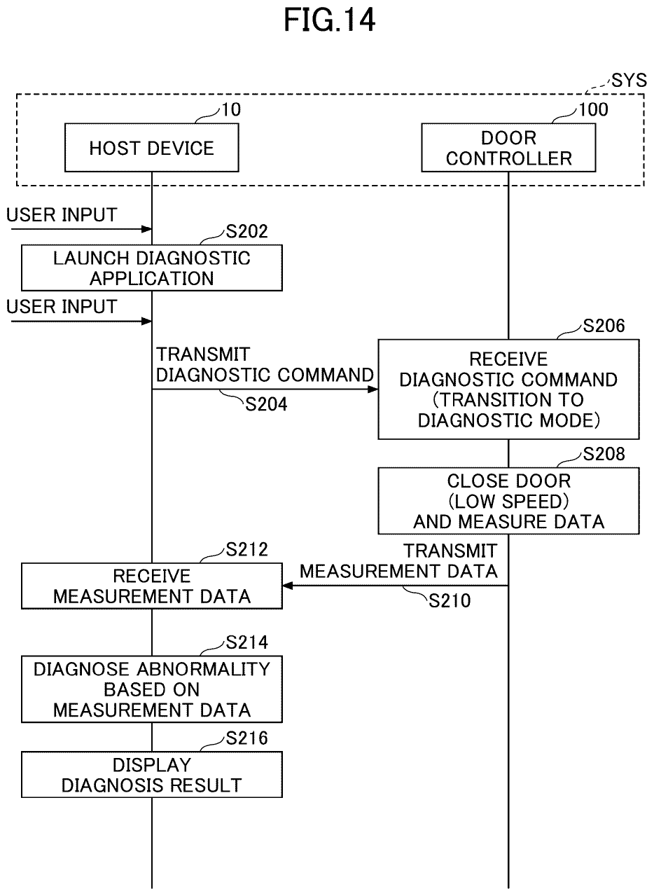

Hereinafter, a second example of the abnormality diagnosis process for the door 80 will be described with reference to FIG. 14.

FIG. 14 is a sequence diagram illustrating the second example of the abnormality diagnosis process for the door 80.

In this example, as in the above first example, the diagnostic system SYS is provided in the train carriage 1, and includes the host device 10 and the door controller 100.

As illustrated in FIG. 14, steps S202, S204, S206, and S208 are the same as steps S102, S104, S106, and S108 in FIG. 13 described above, and accordingly description thereof is omitted.

When the process in step S208 is completed, the input signal detector 113 transmits measurement data that is obtained in step S208 to the host device 10, through the communication unit 112 (step S210).

In step S212, the carriage controller 12 of the host device 10 receives the measurement data transmitted from the door controller 100 in step S210, through the transmission device 16 (step S212).

When the process in step S212 is completed, the carriage controller 12 performs abnormality diagnosis for the door 80, based on the measurement data received in step S212 (step S214).

When the process in step S214 is completed, as in step S116 in FIG. 13 described above, the carriage controller 12 displays the result of the abnormality diagnosis for the door 80, on the display device in a driver's room or a conductor's room, for example (step S216).

As described above, in this example of the diagnostic system SYS, the door controller 100 acquires data in the diagnostic mode in which the door 80 is closed, and then transmits the acquired data to the host device 10. Subsequently, in the diagnostic system SYS, the host device 10 performs abnormality diagnosis for the door 80, based on the data acquired from the door controller 100.

With this arrangement, in this example of the diagnostic system SYS, the host device 10 can acquire measurement data for all the doors 80 of the train carriage 1, and the host device 10 can sequentially accumulate measurement data, and/or a result of abnormality diagnosis, for each door 80. This is because it is easy to secure a sufficiently large storage resource of the host device 10, in comparison to a storage resource of the door controller 100. Thus, the carriage controller 12 can analyze abnormalities of one or more doors 80, based on a measurement data group and/or results of abnormality diagnosis that are acquired during closing of all the doors 80 of the train carriage 1, where the measurement data group and the results of abnormality diagnosis are accumulated in the host device 10. For example, the carriage controller 12 may analyze a history of the diagnosis result (e.g., an estimation value of the clearance δ) for a specific door 80. In this case, the diagnostic system SYS can predict a deterioration state (sign of abnormality) of the door 80, based on a result of the analysis at the carriage controller 12. As a result, the diagnostic system SYS can diagnose the presence or absence of the abnormality in the door 80, in addition to diagnosing the presence or absence of a given sign of the abnormality in the door 80. Thus, the diagnostic system SYS can more appropriately perform abnormality diagnosis for the door 80.

### Another Example of Diagnostic System

Hereinafter, another example of the diagnostic system SYS will be described with reference to FIG. 15.

FIG. 15 is a diagram illustrating another example of the diagnostic system SYS.

As illustrated in FIG. 15, the diagnostic system SYS includes the train carriage 1 (the host device 10 and the door controller 100) and a diagnostic apparatus 2.

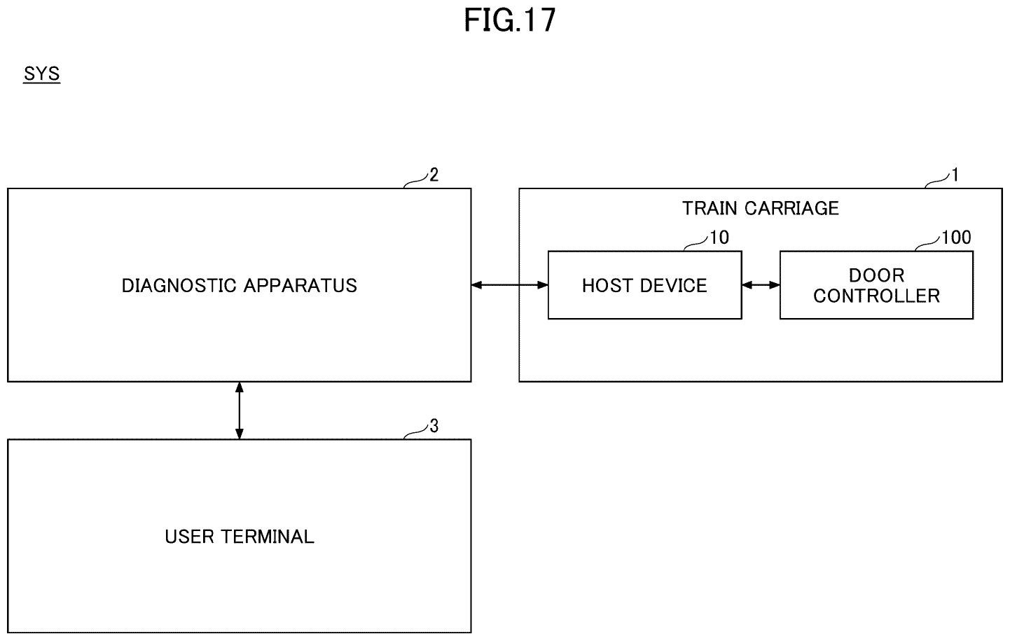

In this example, the train carriage 1 included in the diagnostic system SYS may have one car or a plurality of cars. The same condition may apply to a fourth example (FIG. 17) described below.

The diagnostic apparatus 2 performs abnormality diagnosis for the door 80 in the train carriage 1.

The diagnostic apparatus 2 is provided outside the train carriage 1. The diagnostic apparatus 2 is communicably coupled to the train carriage 1 through a predetermined communication line.

The predetermined communication line includes, for example, a wide area network (WAN), such as a mobile communication network of which an end point is a base station, or a satellite communication network using one or more communication satellites. In addition, the predetermined communication line may include, for example, a local network that is provided at a station, a rail yard, or the like. The predetermined communication line may include, for example, a short-range communication line based on a predetermined communication standard, such as Bluetooth (registered trademark) or WiFi.

The diagnostic apparatus 2 is a server device having relatively high processing capability. The server device may include an on-premise server, a cloud server, or an edge server. In addition, the diagnostic apparatus 2 may include a terminal device that has relatively lower processing capability compared to a server device. The terminal device may be, for example, a stationary terminal device such as a desktop personal computer (PC), or may be, for example, a portable terminal device (mobile terminal) such as a smartphone, a tablet terminal, or a laptop computer.

A function of the diagnostic apparatus 2 may be implemented by any hardware or any combination of hardware and software. For example, the diagnostic apparatus 2 is mainly implemented by a computer that includes a CPU, a memory device, an auxiliary storage device, and an interface device. The memory device is, for example, an SRAM or a dynamic random access memory (DRAM). The auxiliary storage device is, for example, a hard disc drive (HDD), a solid state drive (SSD), an electrically erasable programmable read-only memory (EEPROM), or a flash memory. The interface device includes, for example, a communication interface for communicating with an external device that includes the train carriage 1 (host device 10). The interface device also includes an external interface for coupling an external recording medium. As a result, a program and various types of data that are used to execute an abnormality diagnosis process for the door 80 can be installed from the recording medium to be stored in the auxiliary storage device or the like of the diagnostic apparatus 2. In addition, the program and various types of data that are used to execute the abnormality diagnosis process for the door 80 may be downloaded from the outside of the diagnostic apparatus 2, through the communication interface. The interface device may include a combination of different types of interface devices, in light of types of communication lines to be coupled. The diagnostic apparatus 2 may further include an input device for receiving various inputs from the user, and may include an output device for outputting information to the user. The input device includes, for example, a mechanical-operation input device, such as a mouse, a keyboard, or a touch panel, that receives a mechanical input from the user. The input device may include, for example, a gesture input device or a voice input device that is capable of receiving a user's input through a gesture or a voice, where a camera, a microphone, or the like is used to detect the gesture or the voice. The output device includes, for example, a display device that visually outputs information, and includes a sound output device that audibly outputs information. The display device includes, for example, a liquid crystal display or an organic electroluminescence (EL) display. The sound output device is, for example, a speaker.

### Third Example Related to Abnormality Diagnosis Process for Door

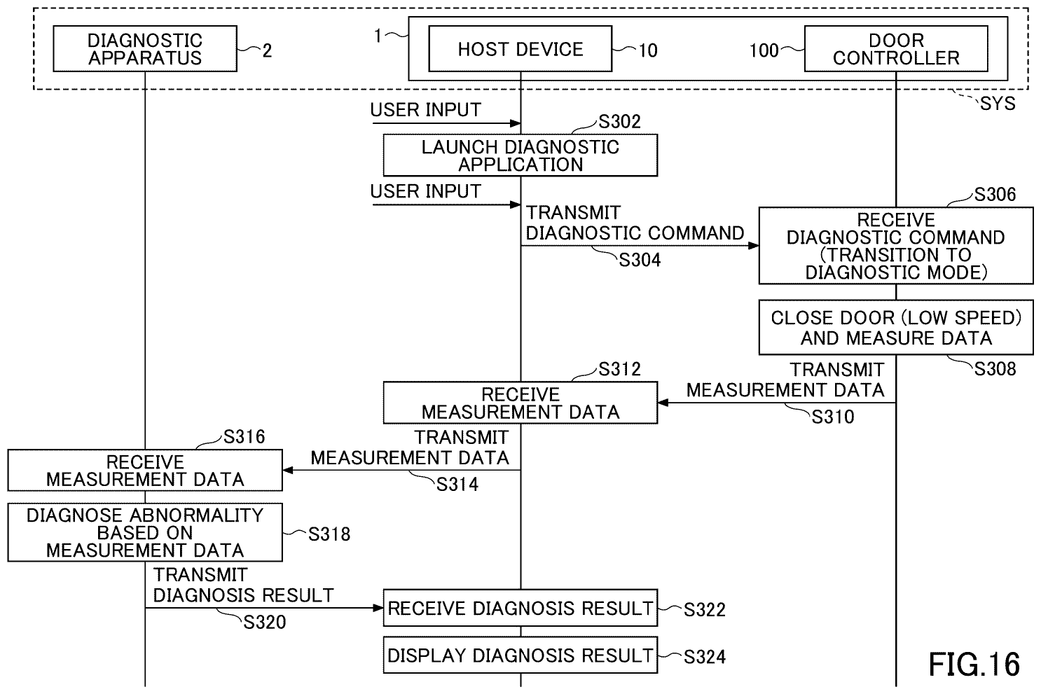

Hereinafter, a third example of the abnormality diagnosis process for the door 80 will be described with reference to FIG. 16,

FIG. 16 is a sequence diagram illustrating the third example of the abnormality diagnosis process for the door 80.

In this example, the diagnostic system SYS in FIG. 15 described above is used.

As illustrated in FIG. 16, steps S302, S304, S306, S308, S310, and S312 are the same as the steps S202, S204, S206, S208, S210, and S212 illustrated in FIG. 14 above, and accordingly description thereof is omitted.

The carriage controller 12 of the host device 10 transmits measurement data that is received in step S312, to the diagnostic apparatus 2 that is situated outside the train carriage 1 (step S314).

The diagnostic apparatus 2 receives the measurement data transmitted from the host device 10 of the train carriage 1 in step S314 (step S316).

The diagnostic apparatus 2 performs abnormality diagnosis for the door 80, based on the measurement data received in step S316 (step S318).

When the process in step S318 is completed, the diagnostic apparatus 2 transmits a result of the abnormality diagnosis of the door 80, to the host device 10 of the train carriage 1 (step S320).

The carriage controller 12 of the host device 10 receives the result of the abnormality diagnosis for the door 80, where the result is transmitted from the diagnostic apparatus 2 in the process in step S320 (step S322).

When the process in step S322 is completed, the carriage controller 12 displays the result of the abnormality diagnosis for the door 80, on a display device that is in a driver's room or a conductor's room, for example, as in steps S116 and S216 in FIGS. 13 and 14 described above (step S324).

As described above, in this example of the diagnostic system SYS, the diagnostic apparatus 2 that is situated outside the train carriage 1 can perform abnormality diagnosis for the door 80. With this arrangement, a processing load for the train carriage 1 (the host device 10 and the door controller 100), which typically has a relatively small processing resource, can be reduced.

In addition, in this example of the diagnostic system SYS, measurement data, and a result of abnormality diagnosis, for each of doors 80 in train carriages 1 having a plurality cars, can be accumulated. As a result, the diagnostic apparatus 2 can analyze the abnormality in the doors 80, based on a measurement data group and/or results of the abnormality diagnosis that are accumulated during the closing of the doors 80 in the train carriages 1 having the plurality of cars. As a result, the diagnostic apparatus 2 can analyze the abnormality in all of the doors 80, based on a measurement data group and/or results of the abnormality diagnosis that are acquired during the closing of the doors 80 in a target train carriage 1, where the measurement data group and/or results of the abnormality diagnosis are accumulated in the diagnostic apparatus 2. For example, the diagnostic apparatus 2 may analyze a history of the abnormality diagnosis result (e.g., an estimation value of the clearance δ) for a specific door 80. With this arrangement, the diagnostic system SYS can predict a deterioration state (a sign of the abnormality) of the door 80, based on an analysis result that is obtained at the diagnostic apparatus 2, to thereby diagnose the presence or absence of the abnormality of the sign of an abnormality in the door 80, as well as diagnosing the presence or absence of the abnormality in the door 80. In addition, in the diagnostic apparatus 2, machine learning, such as clustering, is adopted based on a history of the diagnosis result (e.g., estimation values of clearances 5) for doors 80 in all cars in the train carriages 1, and thus one or more abnormal doors 80, or one or more doors 80 having signs of the abnormalities may be extracted from all the doors 80 in train carriages 1. In such a manner, instead of, or in addition of the abnormality diagnosis process, the diagnostic system SYS can perform abnormality diagnosis for one or more doors 80, by adopting machine learning. Thus, the diagnostic system SYS can more appropriately perform the abnormality diagnosis for the door 80.

A diagnostic application may be installed in the diagnostic apparatus 2. The diagnostic apparatus 2 may transmit a diagnostic command to the train carriage 1 (host device 10), in response to receiving a predetermined input from a user at the diagnostic apparatus 2. When the diagnostic system SYS includes train carriages 1 having a plurality of cars, the diagnostic command is transmitted to a specific train carriage 1 that is designated through a predetermined input from the user.

### Still Another Example of Diagnostic System

Hereinafter, still another example of the diagnostic system SYS will be described with reference to FIG. 17.

FIG. 17 is a diagram illustrating still another example of the diagnostic system SYS.

As illustrated in FIG. 17, the diagnostic system SYS includes the train carriage 1 (the host device 10 and the door controller 100) and the diagnostic apparatus 2, as in the other example (FIG. 15) described above. The diagnostic system SYS also includes a user terminal 3, unlike the other example (FIG. 15).

The user terminal 3 is a terminal device that the user of the diagnostic system SYS uses.

The user terminal 3 is a terminal device that is used, for example, by an inspector who inspects one or more doors 80, or a person or like that is responsible for maintenance and inspection for the train carriage 1. The user terminal 3 may be, for example, a terminal device that the user for the diagnostic apparatus 2 uses.

The user terminal 3 may be, for example, a stationary terminal device such as a desktop personal computer (PC), or may be, for example, a portable terminal device (mobile terminal) such as a smartphone, a tablet terminal, or a laptop PC.

A function of the user terminal 3 may be implemented by any hardware or any combination of hardware and software. For example, the user terminal 3 is mainly implemented by a computer that includes a CPU, a memory device, an auxiliary storage device, an interface device, an input device, and an output device. The memory device includes, for example, an SRAM or a dynamic random access memory (DRAM). The auxiliary storage device includes, for example, an HDD, an SSD, an EEPROM, a flash memory, or the like. The interface device includes, for example, a communication interface for communicating with an external device that includes the diagnostic apparatus 2. The interface device also includes an external interface for coupling an external recording medium. As a result, a program and various data that are used to execute an abnormality diagnosis process for the door 80 can be installed from the recording medium to be stored in the auxiliary storage device or the like of the user terminal 3. In addition, the program and various data that are used to execute the abnormality diagnosis process for the door 80 may be downloaded from the outside of the user terminal 3, through the communication interface. Further, the interface device may include different types of interface devices, in light of the types of communication lines to be coupled. The input device includes, for example, a mechanical-operation input device such as a mouse, a keyboard, or a touch panel that receives a mechanical input from a user. The input device may include, for example, a gesture input device or a voice input device that is capable of receiving an input by a gesture or voice from a user by a camera, a microphone, or the like. The output device includes, for example, a display device that visually outputs information and a sound output device that audibly outputs information. The display device is, for example, a liquid crystal display or an organic electroluminescence (EL) display. The sound output device includes, for example, a speaker.

### Fourth Example of Abnormality Diagnosis Process for Door

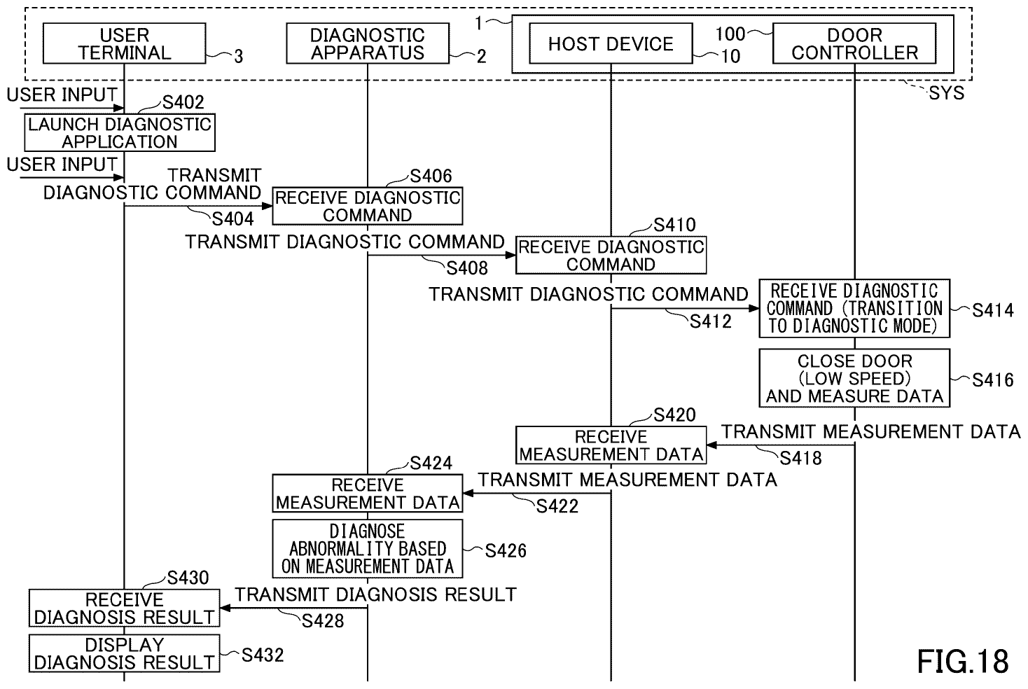

Hereinafter, a fourth example of the abnormality diagnosis process for the door 80 will be described with reference to FIG. 18.

FIG. 18 is a sequence diagram illustrating the fourth example of the abnormality diagnosis process for the door 80.

In this example, the diagnostic system SYS illustrated in FIG. 17 is used.

As illustrated in FIG. 18, the user terminal 3 launches a diagnostic application, in response to receiving a predetermined input from the user (step S402).

After the process in step S402 is completed, the user terminal 3 transmits a diagnostic command to the diagnostic apparatus 2, in response to receiving a predetermined input of a request from the user to perform abnormality diagnosis for the door 80 (step S404).

The diagnostic command transmitted from the user terminal 3, which is used at train carriages 1 having a plurality of cars, specifies a target train carriage 1 for which abnormality diagnosis is performed on one or more doors 80. The target train carriage 1 is specified using a predetermined input from the user.

The diagnostic apparatus 2 receives the diagnostic command transmitted from the user terminal 3 in the process in step S404 (step S406).

When the process in step S406 is completed, the diagnostic apparatus 2 relays the diagnostic command from the user terminal 3 to transmit the diagnostic command to the target train carriage 1 (the host device 10) (step S408).

The host device 10 (carriage controller 12) in the target train carriage 1 receives the diagnostic command transmitted in step S408 (step S410).

The carriage controller 12 relays the diagnostic command received in step S408 to transmit the diagnostic command to the door controller 100 via the transmission device 16 (step S412).

Steps S414, S416, S418, S420, S422, S424, and S426 are the same as steps S306, S308, S310, S312, S314, S316, and S318 in the third example (FIG. 16) described above, and description thereof is omitted.

When the process in step S426 is completed, the diagnostic apparatus 2 transmits a result of the abnormality diagnostic for the door 80 in step S426, to the user terminal 3 (step S428).

The user terminal 3 receives the result of the abnormality diagnostic transmitted from the diagnostic apparatus 2 in step S428 (step S430).

When the process in step S430 is completed, the user terminal 3 displays the result of the abnormality diagnosis for the door 80, on an output device (display device) of the user terminal 3 (step S432).

With this arrangement, the user can check the result of the abnormality diagnosis for the door 80, by using the user terminal 3.

As described above, in this example, in the diagnostic system SYS, the user terminal 3 transmits a request (diagnostic command) to perform abnormality diagnosis for the door 80, to the train carriage 1 through the diagnostic apparatus 2, and then the user terminal 3 notifies the user of the result of the abnormality diagnosis for the door 80.

With this arrangement, with use of the user terminal 3, the user for the diagnostic system SYS can request a result of abnormality diagnosis for the door 80 to check the result of the abnormality diagnosis for the door 80. Therefore, for example, a user other than the user who can directly use the train carriage 1 or the diagnostic apparatus 2 can check the result of the abnormality diagnosis, by using the user terminal 3. For example, a person in charge of a manufacturer who handles service parts of one or more doors 80 can recognize a situation in which an abnormality occurs in one or more doors 80 for each car of the train carriage 1, and then optimize management or the like for the service parts. For example, a person who maintains and inspects one or more train carriages 1 can carry the user terminal 3, performs maintenance and inspection work for one or more doors 80 of an actually used train carriage 1, while checking the result of the abnormality diagnosis of each door 80. Therefore, convenience of the user for the diagnostic system SYS can be improved.

### Operation

Hereinafter, the operation of the diagnostic apparatus, the diagnostic system, and the program according to the present embodiment will be described.

In the present embodiment, a diagnostic apparatus acquires time series data during a time period in which a door closes, upon occurrence of a condition in which a car-side pin in a train carriage is maintained in a state where a locking device does not restrict the pin from moving downward, the pin being configured to drop into a door-side recess in the train carriage by weight of the pin to allow for a locked state of the door. The time series data includes first time series data of a position of the door, and includes second time series data of an output of a detector configured to detect whether the pin has dropped. The diagnostic apparatus may include, for example, the diagnostic apparatus 2, the carriage controller 12, or the door controller 100 described above. The train carriage is, for example, the above train carriage 1. The door is, for example, the door 80 described above. The recess is, for example, the lock hole 223A. The pin is, for example, the pin 231. The locking device is, for example, the locking device 50 described above. Then, the diagnostic apparatus diagnoses, based on the acquired time series data, an abnormality in a positional relationship between the pin and the recess in an opening and closing direction of the door that is in the unlocked state.

In the present embodiment, in a diagnostic system, a door in a train carriage closes, upon occurrence of a condition in which a car-side pin in the train carriage is maintained in a state where a locking device does not restrict the pin from moving downward, the pin being configured to drop into a door-side recess in the train carriage by weight of the pin to allow for a locked state of the door. Also, in the diagnostic system, time series data is acquired during a time period in which the door closes. The time series data includes first time series data of a position of the door, and includes second time series data of an output of a detector configured to detect whether the pin has dropped. Further, in the diagnostic system, an abnormality in a positional relationship between the pin and the recess in an opening and closing direction of the door that is in the locked (fully closed) state is diagnosed based on the acquired time series data.

An information processing apparatus may execute a diagnosis method. Specifically, in the diagnosis method, the information processing apparatus acquires time series data during a time period in which a door closes, upon occurrence of a condition in which a car-side pin in a train carriage is maintained in a state where a locking device does not restrict the pin from moving downward, the pin being configured to drop into a door-side recess in the train carriage by weight of the pin to allow for a locked state of the door. The time series data includes first time series data of a position of the door, and includes second time series data of an output of a detector configured to detect whether the pin has dropped. Then, the information processing apparatus diagnoses, based on the acquired time series data, an abnormality in a positional relationship between the pin and the recess in an opening and closing direction of the door that is in the locked (fully closed) state.

A program may be executed by an information processing apparatus. Specifically, the program causes the information processing apparatus to acquire time series data during a time period in which a door closes, upon occurrence of a condition in which a car-side pin in a train carriage is maintained in a state where a locking device does not restrict the pin from moving downward, the pin being configured to drop into a door-side recess in the train carriage by weight of the pin to allow for a locked state of the door. The time series data includes first time series data of a position of the door, and includes second time series data of an output of a detector configured to detect whether the pin has dropped. Then, the program causes the information processing apparatus to diagnose, based on the acquired time series data, an abnormality in a positional relationship between the pin and the recess in an opening and closing direction of the door that is in the locked (fully closed) state.

With this arrangement, the car-side pin can be inserted in the door-side recess in accordance with a position of the door that is being closed. Thus, the diagnostic apparatus or the like can identify the position of the door during a period, for example, from a first timing, at which the output of the detector changes from a state where the drop of the pin is not detected to a state where the drop of the pin is detected, to a second timing at which the pin drops into the recess to be inserted in the recess. Also, the diagnostic apparatus or the like can identify, as a stop position of the door that closes, a fully closed position of the door, for example, based on the first time series data of the position of the door. With this arrangement, the diagnostic apparatus or the like can evaluate, based on the identified position of the door, the positional relationship between the pin and the recess in the opening and closing direction of the door that is in the fully closed state. Thus, the diagnostic apparatus or the like can diagnose the abnormality in the positional relationship between the pin and the recess.

Further, in the present embodiment, upon occurrence of a condition in which a pin is maintained in a state where a locking device does not restrict the pin from moving downward, in conjunction with a condition in which a door is closed at a constant speed, time series data may be acquired. The constant second speed is the speed V2 described above.

With this arrangement, accuracy in measuring the position of the door can be improved. For example, even when there is an offset between a starting timing of the drop of the pin and a timing at which the output of a detector changes, the position of the door can be relatively easily estimated at a starting timing at which the pin drops, in consideration of the fact that a time difference derived from the offset is determined based on the constant speed of the door. Thus, a diagnostic apparatus or the like can more appropriately evaluate the positional relationship between the pin and the recess in an opening and closing direction of the door that is in a fully closed state. As a result, the abnormality in the positional relationship can be diagnosed more appropriately.

In the present embodiment, the above constant speed may be lower than a speed at which a door is closed in a case where a passenger is to get on and off a train carriage. The speed at which the door is closed in the case where the passenger is to get on and off the train carriage is the speed V1 described above.

With this arrangement, accuracy in measuring a position of the door can be improved without increasing or the like of measured cycles for the door position. For example, even when there is an offset between a timing of the start of the drop of a pin and a timing at which the output of a detector changes, changes in the door position during a time period that is derived from a time difference corresponding to the offset are reduced. Thus, in consideration of the time difference, the door position at the timing of the start of the drop of the door can be estimated more accurately. In this case, a diagnostic apparatus or the like can more appropriately evaluate a positional relationship between the pin and a recess in an opening and closing direction of the door that is in a fully closed state. As a result, the abnormality in the positional relationship can be diagnosed more appropriately.

In the present embodiment, a diagnostic apparatus may determine, based on second time series data of the output of a detector, a first timing at which the output of the detector changes from a first state where the drop of a pin is not detected, to a second state where the drop of the pin is detected. The first timing is the time t1 described above. The diagnostic apparatus may also determine, based on the first timing and first time series data of a position of a door, a first position of the door at a timing (start of the drop) at which the pin starts to be inserted in a recess. The first position is the position P0 described above. Further, the diagnostic apparatus may determine a second position at which the door is in a fully closed state, based on first time series data of the position of the door. The second position is, for example, the fully closed position P2 described above. The diagnostic apparatus further may diagnose an abnormality in a positional relationship between the pin and the recess in an opening and closing direction of the door that is in a fully closed state, based on the first position and the second position.

With this arrangement, the diagnostic apparatus or the like can evaluate the abnormality in the positional relationship between the pin and the recess in the opening and closing direction of the door that is in the fully closed state, based on the first position at a timing (start of the drop) at which the pin starts to be inserted in the recess and, the second position at which the door is at the fully closed position. Thus, the diagnostic apparatus can diagnose the abnormality, based on a result of the evaluation.

In the present embodiment, a diagnostic apparatus may determine (estimate) a first position of a door at a timing (start of the drop) at which a pin starts to be inserted in a recess, based on (i) a first timing, (ii) first time series data of a position of the door, and (iii) an expected time difference between a timing (start of the drop) at which the pin starts to be inserted in the recess and a second timing at which a detector detects the drop of the pin. The time difference is, for example, the time difference Δt described above.

With this arrangement, when there is an offset between the timing (start of the drop) at which the pin starts to be inserted in the recess and the second timing at which the detector detects the drop of the pin, the diagnostic apparatus or the like can estimate a positional relationship between the pin and the recess in an opening and closing direction of the door that is in a fully closed state, in consideration of a time difference that is derived from the offset. Thus, the diagnostic apparatus or the like can diagnose the positional relationship more appropriately.

In the present embodiment, a diagnostic apparatus may determine (estimate) a clearance between a pin and a recess in a case where a door is in a fully closed state, based on a first position and a second position. The clearance is, for example, the clearance δ described above. The diagnostic apparatus may also diagnose the presence or absence of an abnormality, based on whether the determined (estimated) clearance is greater than a predetermined criterion. The predetermined criterion is, for example, the threshold δth described above.

With this arrangement, the diagnostic apparatus or the like can estimate the clearance between the pin and the recess in an opening and closing direction. Thus, the diagnostic apparatus or the like can diagnose an anomality in a positional relationship between the pin and the recess in the opening and closing direction of the door that is in a fully closed state.

In the present embodiment, a diagnostic apparatus may determine, based on second time series data of the output of a detector, a first timing at which the output of the detector changes from a first state where the drop of a pin is not detected, to a second state where the drop of the pin is detected. The first timing is, for example, the time t1 described above. The diagnostic apparatus may also determine, based on the first timing and first time series data of a position of a door, a first position of the door at the first timing at which the output of the detector changes from the first state to the second state. The first position is, for example, the position P1 described above. The diagnostic apparatus may further determine a second position at which the door is in a fully closed state, based on the first time series data. The second position is, for example, the fully closed position P2 described above. The diagnostic apparatus may determine, based on the first position and the second position, a first travel distance of the door that moves during a first time period from the first timing to a second timing at which the door enters the fully closed state. The first travel distance is, for example, the travel distance TL2 described above. The diagnostic apparatus may diagnose an abnormality, based on the first travel distance and an expected second travel distance of the door that moves during a second time period from a timing (start of the drop) at which the pin starts to be inserted in a recess, to a second timing at which the detector detects the drop of the pin. The second travel distance is, for example, the travel distance TL1 described above.

With this arrangement, when there is an offset between the timing (start of the drop) at which the pin starts to be inserted in the recess and the second timing at which the detector detects the drop of the pin, the diagnostic apparatus or the like can estimate a positional relationship between the pin and the recess in an opening and closing direction of the door that is in a fully closed state, in consideration of a time difference that is derived from the offset. Thus, the diagnostic apparatus or the like can diagnose the positional relationship more appropriately.

In the present embodiment, a second travel distance may be determined based on (i) an expected time difference between a timing (start of the drop) at which a pin starts to be inserted in a recess and a second timing at which a detector detects the drop of the pin and (ii) a speed of the door during a second time period that is derived from the time difference.

With this arrangement, when there is an offset between the timing (start of the drop) at which the pin starts to be inserted in the recess and the second timing at which the detector detects the drop of the pin, the diagnostic apparatus or the like can determine a travel distance of the door that moves during a time period that is derived from the offset.

In the present embodiment, a diagnostic apparatus or the like may determine (estimate), based on a first travel distance and a second travel distance, a clearance between a pin and a recess in a case where a door is in a fully closed state. The diagnostic apparatus or the like may also diagnose the presence or absence of an abnormality, based on whether the determined (estimated) clearance is greater than a predetermined criterion.

With this arrangement, the diagnostic apparatus or the like can estimate the clearance between the pin and the recess in an opening and closing direction, to diagnose a positional relationship between the pin and the recess in the opening and closing direction of the door that is in a fully closed state.

Although the embodiments are described above in detail, the present disclosure is not limited to a specific embodiment, and various modifications and changes can be made within the scope of a gist described in the present disclosure.

In the embodiments described below, an abnormality in a positional relationship between a door-side object and a car-side object (a door-side pin and a car-side recess) in an opening and closing direction of a door can be diagnosed.

What is claimed is:

1. A diagnostic apparatus comprising:
circuitry configured to:
acquire time series data during a time period in which a door closes, upon occurrence of a condition in which a car-side pin in a train carriage is maintained in a state where a locking device does not restrict the pin from moving downward, the pin being configured to drop into a door-side recess in the train carriage by weight of the pin to allow for a locked state of the door, and the time series data including
first time series data of a position of the door, and
second time series data of an output of a detector configured to detect whether the pin has dropped, and
diagnose, based on the acquired time series data, an abnormality in a positional relationship between the pin and the recess in an opening and closing direction of the door that is in the locked state.

2. The diagnostic apparatus according to claim 1, wherein the circuitry is configured to acquire the first time series data and the second time series data, upon occurrence of the condition in which the pin is maintained in the state where the locking device does not restrict the pin from moving downward, in conjunction with a condition in which the door is closed at a constant speed.

3. The diagnostic apparatus according to claim 2, wherein the constant speed is lower than a speed at which the door is closed in a case where a passenger is to get on and off the train carriage.

4. The diagnostic apparatus according to claim 1, wherein the circuitry is configured to:
determine, based on the second time series data, a first timing at which the output of the detector changes from a first state where the drop of the pin is not detected, to a second state where the drop of the pin is detected,
determine, based on the first timing and the first time series data, a first position of the door at a timing at which the pin starts to be inserted in the recess,
determine a second position at which the door is in a fully closed state, based on the first time series data, and
diagnose the abnormality, based on the first position and the second position.

5. The diagnostic apparatus according to claim 4, wherein the circuitry is configured to:
determine the first position, based on (i) the first timing, (ii) the first time series data, and (iii) an expected time difference between the timing at which the pin starts to be inserted in the recess and a second timing at which the detector detects the drop of the pin.

6. The diagnostic apparatus according to claim 4, wherein the circuitry is configured to:
determine a clearance between the pin and the recess in a case where the door is in a fully closed state, based on the first position and the second position, and
diagnose the presence or absence of the abnormality, based on whether the clearance is greater than a predetermined criterion.

7. The diagnostic apparatus according to claim 1, wherein the circuitry is configured to:
determine, based on the second time series data, a first timing at which the output of the detector changes from a first state where the drop of the pin is not detected to a second state where the drop of the pin is detected,
determine, based on the first timing and the first time series data, a first position of the door at the first timing at which the output of the detector changes from the first state to the second state,
determine a second position at which the door is in a fully closed state, based on the first time series data, and
determine, based on the first position and the second position, a first travel distance of the door that moves during a first time period from the first timing to a second timing at which the door enters the fully closed state, and
diagnose the abnormality, based on the first travel distance and an expected second travel distance of the door that moves during a second time period from a timing at which the pin starts to be inserted in the recess, to a second timing at which the detector detects the drop of the pin.

8. The diagnostic apparatus according to claim 7, wherein the circuitry is configured to determine the second travel distance based on (i) an expected time difference between the timing at which the pin starts to be inserted in the recess and the second timing and (ii) a speed of the door during the second time period that is derived from the time difference.

9. The diagnostic apparatus according to claim 7, wherein the circuitry is configured to
determine, based on the first travel distance and the second travel distance, a clearance between the pin and the recess in a case where the door is in the fully closed state, and
diagnose the presence or absence of the abnormality, based on whether the determined clearance is greater than a predetermined criterion.

10. A diagnostic system comprising:
circuitry configured to:
close a door in a train carriage, upon occurrence of a condition in which a car-side pin in the train carriage is maintained in a state where a locking device does not restrict the pin from moving downward, the pin being configured to drop into a door-side recess in the train carriage by weight of the pin to allow for a locked state of the door,
acquire time series data during a time period in which a door closes, the time series data including
first time series data of a position of the door, and
second time series data of an output of a detector configured to detect whether the pin has dropped, and
diagnose, based on the acquired time series data, an abnormality in a positional relationship between the pin and the recess in an opening and closing direction of the door that is in the locked state.

11. A diagnostic method executed by an information processing apparatus, the diagnostic method comprising:
acquiring time series data during a time period in which a door is closed, upon occurrence of a condition in which a car-side pin in a train carriage is maintained in a state where a locking device does not restrict the pin from moving downward, the pin being configured to drop into a door-side recess in the train carriage by weight of the pin to allow for a locked state of the door, and the time series data including
first time series data of a position of the door, and
second time series data of an output of a detector configured to detect whether the pin has dropped; and
diagnosing, based on the acquired time series data, an abnormality in a positional relationship between the pin and the recess in an opening and closing direction of the door that is in the locked state.

12. A non-transitory computer readable medium storing a program for causing a computer to execute the diagnostic method of claim 11.
